(19) United States
(12) Patent Application Publication
(10) Pub. No.: US 2014/0319209 A1
(43) Pub. Date: Oct. 30, 2014

(54) MEMORY TAG HYBRID MULTIDIMENSIONAL BAR-TEXT CODE WITH REWARDS AND INCENTIVES

(71) Applicant: Robert Dale Beadles, Lodi, CA (US)

(72) Inventor: Robert Dale Beadles, Lodi, CA (US)

(21) Appl. No.: 14/327,502

(22) Filed: Jul. 9, 2014

Related U.S. Application Data
(63) Continuation-in-part of application No. 14/269,164, filed on May 4, 2014.
Application No. 14/269,164 is a continuation-in-part of application No. 14/106,656, filed on Dec. 13, 2013.
Application No. 14/106,656 is a continuation-in-part of application No. 14/081,766, filed on Nov. 15, 2013.
Application No. 14/081,766 is a continuation-in-part of application No. 13/925,724, filed on Jun. 25, 2013.
Application No. 13/925,724 is a continuation-in-part of application No. 13/759,863, filed on Feb. 5, 2013.
(60) Provisional application No. 61/711,216, filed on Oct. 9, 2012.

(51) Int. Cl. G06K 19/06; G06Q 30/02

(52) U.S. Cl. CPC G06K 19/06037; G06Q 30/0207
USPC 235/375; 235/494

(57) ABSTRACT

An apparatus and method for cloud-based storage, retrieval and sharing of files tagged with scannable tags and alphanumeric coding is provided. This application and method includes generating a scannable code tag and activating the scannable code tag when the scannable code tag is scanned. Activating the scannable code tag includes tagging a video, audio or other file with the scannable code tag by associating the scannable code tag with the file and tagging a reward with the scannable code tag by associating the scannable code tag with the reward.

### CROSS REFERENCE TO RELATED APPLICATIONS

This application is a continuation-in-part of U.S. Non-Provisional application Ser. No. 14/269,164, filed May 4, 2014, which continuation-in-part of U.S. Non-Provisional application Ser. No. 14/106,656, filed Dec. 13, 2013, which is a continuation-in-part application of U.S. Non-Provisional application Ser. No. 14/081,766, filed Nov. 15, 2013, which is a continuation-in-part of U.S. Non-Provisional application Ser. No. 13/925,724, filed Jun. 25, 2013, which is a continuation-in-part of U.S. Non-Provisional application Ser. No. 13/759, 863 filed Feb. 5, 2013, which claims the benefit of U.S. Provisional Application No. 61/711,216 filed Oct. 9, 2012. The entire contents of each patent application identified above is incorporated by reference herein as if fully set forth to provide continuity of disclosure.

### STATEMENT REGARDING FEDERAL SPONSORED RESEARCH OR DEVELOPMENT

Not Applicable

### REFERENCE TO SEQUENCE LISTING, A TABLE, OR A COMPUTER PROGRAM

Not Applicable

### BACKGROUND

1. Field of Invention

Embodiments relate to mobile tagging, and more particularly but not exclusively, to mobile tagging utilizing multidimensional barcodes. Embodiments also relate to PC and other computer tagging.

2. Description of Related Art

Multidimensional bar codes, such as the two dimensional (2D) Quick Response (QD) (trademarked) barcode as described in Masahiro, U.S. Pat. No. 5,726,435 and Masahiro, Jap. Pat. No. 2938338, allow users to enjoy both the convenience of traditional print media and the completeness of online media. Multidimensional bar codes with embedded URL codes often appear in magazine articles, business cards, item tags, and advertisements. Individuals, who wish to supplement this published media, may do so by taking a picture of a 2D bar code with a camera enabled cell phone that will redirect them to the programmed URL. The programmed URL can contain unlimited information to supplement the published media, including a products details, videos or contact information. Publishers and users can also print their own 2D barcodes for others.

For the most part, 2D bar codes have been commercially unavailable to individuals who merely want to generate a bar code and associate it with a video, photograph or document. Ordinary consumers and small businesses, find that the expense of investing into this technology exceeds the benefit provided. Further, another difficulty in using this technology is that the URL or video link usually requires a published website or hosting server. Moreover, current 2D bar codes cannot be processed visually and typically require a scanning mechanism.

Cloud storage providers, examples of whom include: Google Drive (trademarked), Rapidshare (trademarked) or Mega, are based on a model of storage where users upload data onto third party hosted servers. Cloud storage providers own large data centers and allow their customers to pay to buy or lease storage capacity on these websites. Some providers, like Rapidshare (trademarked), encourage sharing of user-submitted data by generating unique URL links to user-submitted content. In turn, users share their content with other by providing a URL link to this content. Typically, those who wish to enjoy user-submitted content must download this content through the unique link. For these reasons, clouds storage has become an incredibly popular service for users to upload and share photographs, videos, documents and other information.

Cloud storage models contain numerous disadvantages. URL links are often difficult to input by a user, unattractive on the text, and out of place when inserted into printed media. Further, users are often forced to download content before they may access it. Moreover, the interface of a cloud storage system is not friendly for a novel user and the files are not easily retrievable and shareable.

Accordingly, there exists a need to provide an improved, more user friendly, 2D code tagging systems, storage system, and processes for retrieving these tagged images for mobile phones, computers and other electronic devices.

Current U.S. Classification: 283/75, 283/77, 235/494, 235/462.1, 235/462.9

### BRIEF SUMMARY OF THE INVENTION

The present invention seeks to combine available and existing aspects of multidimensional tagging with the cloud storage's capabilities in a novel manner. This combination allows user to submit video, audio or other files onto a cloud based storage system. This process is achieved by and through an internet or network based network. The application tags each user submitted file by associating each file with a unique URL, 2D barcode and alphanumeric code. This hybrid multi-dimensional bar text code combination enables a user to, either with a 2D bar code or alphanumeric code, immediately view photographs, videos, audio files, or other data stored on a cloud storage system conveniently.

The present invention includes a convenient and easy storage system for users to submit their own video, audio or other files. One embodiment includes a cloud based file storage system where submitted files will be housed and linked with their tagged associated URL, 2d bar code and alphanumeric bar codes. In one embodiment, the user has the option to password protect their submitted files.

According to the preferred embodiment of this present invention, data is stored and tagged through the use of an electronic mobile application that is connected to the internet or network. This application stores user submitted data by processing it through a server that is connected to a cloud based database for storage, in one embodiment. Further, in one embodiment, this application tags user submitted data by associating files submitted by a user with a unique 2D barcode, alphanumeric bar code and a URL link. This application also grants the user many managerial functions over the submitted data including the power to delete files, add titles, add passwords, duplicate 2D barcodes, as well as other features. The application includes a component that allows a user to pay for the use of the application. Alternatively, the function of the above preferred embodiment may be performed by the application's website if the user should so choose.

An illustrative example of one embodiment of this present invention first starts with a person or business entity to producing a printed text such as a post card, sign, greeting card, advertisement or invitation to offer. Shortly thereafter, the person or business entity supplements their printed text with the hybrid multi dimensional bar text code of this present invention. Both the 2D barcode and text produced below said barcode are tagged and associated directly with a video, photograph, audio file, contact information, or other data supplied by the producing person or business entity and stored on this present invention's server. The printed text, along with the 2D barcode and alphanumeric code, is conveniently shared amongst friends, customers, businesses or provided for the general public to view.

Using the camera function of a smart phone, the user takes a photograph of the 2D barcode. Alternatively, the user may enter the alphanumeric code into a smart phone, computer or similar electronic device. The smart phone or personal computer then automatically initiates a communication with a third party cloud server, where the associated photograph, video, audio file, contact information or other stored data is retrieved for the user to listen to or view.

As a non-limiting example, a musical band, who is interested in promoting their music, will publish a printed advertisement, like a band poster, that includes a hybrid multi dimensional bar text code which they have associated with a sound file. A user captures a picture, using a smart phone, or inputs the alpha numeric number into his cell phone. Once the smart phone has processed the code or image, the smart phone transmits the audio file which is stored on a cloud based server. Thus, this present invention allows printed advertisements to be conveniently supplemented with media in a new and novel manner.

According to one aspect, there is provided a method for mobile or other computer tagging. The method can comprise: generating a hybrid multi dimensional bar-text code, wherein generating said hybrid code comprises generating a multi dimensional barcode including text symbols; tagging a video, audio or other file with said hybrid multi dimensional bar-text code by associating said generated hybrid code with said file; storing said tagged file for retrieval; and retrieving said tagged file utilizing said hybrid multi dimensional bar-text code.

According to another aspect, there is provided an apparatus for mobile or other computer tagging. The apparatus comprises: at least one processor operably connectable to a plurality of user devices; a data bus coupled to said at least one processor; a computer-usable medium embodying computer program code, said computer-usable medium being coupled to said data bus; and said computer program code comprising instructions executable by said processor and configured for performing the aforesaid method for mobile or other computer tagging.

A computer-usable medium for mobile or other computer tagging system, said computer-usable medium embodying computer program code, said computer program code comprises computer executable instructions configured for performing the aforesaid method for mobile or other computer tagging.

Some embodiments provide a method for providing a reusable multi-layer scannable tag, the method comprising (a) generating a scannable code tag; and (b) activating the scannable code tag when the scannable code tag is scanned, wherein activating the scannable code tag comprises: (i) tagging a video, audio or other file with the scannable code tag by associating the scannable code tag with the file; and (ii) tagging a reward with the scannable code tag by associating the scannable code tag with the reward.

Other embodiments provide a non-transitory computer readable storage media that includes executable instructions that when executed by a processor perform methods described herein.

### BRIEF DESCRIPTION OF THE DRAWINGS

FIG. 1 is a flow chart outlining a method for electronic device tagging according to one embodiment;

FIG. 2 is a flow chart outlining another possible method of this present invention for a user of this present invention to tag and associate a file with a multidimensional bar code and alphanumeric code, and then the process by which a different user may then retrieve the associated file by only having access to the previous user's multidimensional bar code tag or alpha numeric code;

FIG. 3 depicts flow chart outlining one method of a registered user to access and manage associated file according to one embodiment, including removing videos, adding videos, posting links to social media websites, adding passwords as well as other options;

FIG. 4 depicts an illustrative shot of a mobile user taking a photograph of a postcard that includes a hybrid multidimensional bar-text code according to one embodiment;

FIG. 5 is a text image of an example of one of the many URLs generated and utilized by the present invention for the purposes of tagging user submitted data;

FIG. 6 depicts a flow chart outlining a method for electronic device tagging according to one embodiment;

FIG. 7 is an exemplary schematic diagram of one of many different environments wherein the embodiments may be practiced;

FIG. 8 depicts a flow chart outlining another method used by a new user of one embodiment of this present invention by which the user uploads a file and a process by which the application generates a unique URL link, 2D Code, and alphanumeric code for each file uploaded by the user according to one embodiment;

FIG. 9 is a block diagram depicting one of many available sample configurations of a network and internet communication system which include: a smart phone device, computer device, servers, and common network connections;

FIG. 10 is a block diagram that depicts a smart phone or mobile communication device with an attached camera and internet capabilities, in accordance with one of many sample configurations available that the present disclosure may function with;

FIG. 11 is an illustrative example that depicts a user one method of using this present invention involving the use of a hybrid multi dimensional bar text code and the user's physical sense of vision provided by their eyes;

FIG. 12 is a block diagram that depicts one of the many available methods by which users may set up a subscription for the application of this present invention by the use of a payment gateway, merchant account and a bank.

FIG. 13 is a chart of various types of sticker-type momentos that users may use to stick onto substrates, such as envelopes for wedding invitations, for example, to provide invitees with access to extra information as mentioned previously.

FIG. 14 is an illustrative example of a momento using this present invention involving the use of a hybrid multi dimensional bar text code.

FIG. 15 is an illustrative example of momento that can be used to hold or showcase pictures or player stats related to events, in particular and non-limiting example with youth sporting teams, where information regarding the player, team, position, coach, year, using this present invention involving the use of a hybrid multi dimensional bar text code.

FIGS. 16-19 are illustrative examples of momentos that can be used to showcase an event, such as, but not limited to a sports game or a wedding, for example using this present invention involving the use of a hybrid multi dimensional bar text code.

FIGS. 20-23 are illustrative examples of momentos that can be used to showcase an event, such as, but not limited to, a sports game or a wedding, for example using this present invention involving the use of a hybrid multi dimensional bar text code.

FIGS. 24-27 are illustrative examples of momentos that can be used to showcase an event, such as, but not limited to, a sports season or a wedding, for example where there are spaces for at least one picture and using this present invention involving the use of a hybrid multi dimensional bar text code.

FIG. 28 is an illustrative example that depicts one embodiment of the present invention involving the use of hybrid multi-dimensional bar text code of multiple scannable layers in an exploded view.

FIG. 29. is an illustrative example that depicts one embodiment of the present invention involving the use of layered QR codes.

FIG. 30. Is an illustrative example that depicts one embodiment of the present invention showing the use of layered RFID tags (implanted).

FIG. 31. is a (flow) chart illustrating one of the many embodiments of the present invention, where a user can scan a tag, upload a file to the cloud, associated with the tag, where a second user may scan the tag and watch the video, and repeat the process when sending a response using another layer within the scannable tag.

FIG. 32 is a schematic diagram of computing architecture that is used to practice aspect of the present invention.

FIG. 33 is a (flow) chart illustrating a method for multilayer tag creation, use, and metric tracking relative to the tag and an associated file.

FIG. 34 is a (flow) chart illustrating a method for multilayer tag creation, use, and metric tracking relative to the tag and a plurality of associated files that can be associated with various distinct layers of the multilayer tag.

FIG. 35 is a (flow) chart method for creating and updating a multi-layer scannable tag.

FIG. 36 is a (flow) chart of a method for creating a multi-layer scannable tag with a plurality of files associated with a plurality of layers of the multi-layer scannable tag.

FIG. 37 is a (flow) chart of a method for creating a multi-layer scannable tag and associating the same with an advertisement or promotion.

FIG. 38 illustrates two display devices that are configured to display an owner dashboard in a desktop format and a mobile format.

FIG. 39A is a flowchart of an example method for providing a scannable code tag that is associated with both a tagged file and a tagged reward.

FIG. 39B is a flowchart of another method for generating and activating a scannable code tag.

FIG. 40 is a flowchart of a method for using a scannable code tag to obtain a reward.

FIG. 41 is a flowchart of a method for providing a multi-layer scannable tag.

FIG. 42 is a flowchart of another method for providing a multi-dimensional barcode.

FIG. 43 is a diagrammatic representation of an example machine in the form of a computer system.

FIG. 44 illustrates a mobile device scanning a scannable code tag associated with one of a plurality of objects.

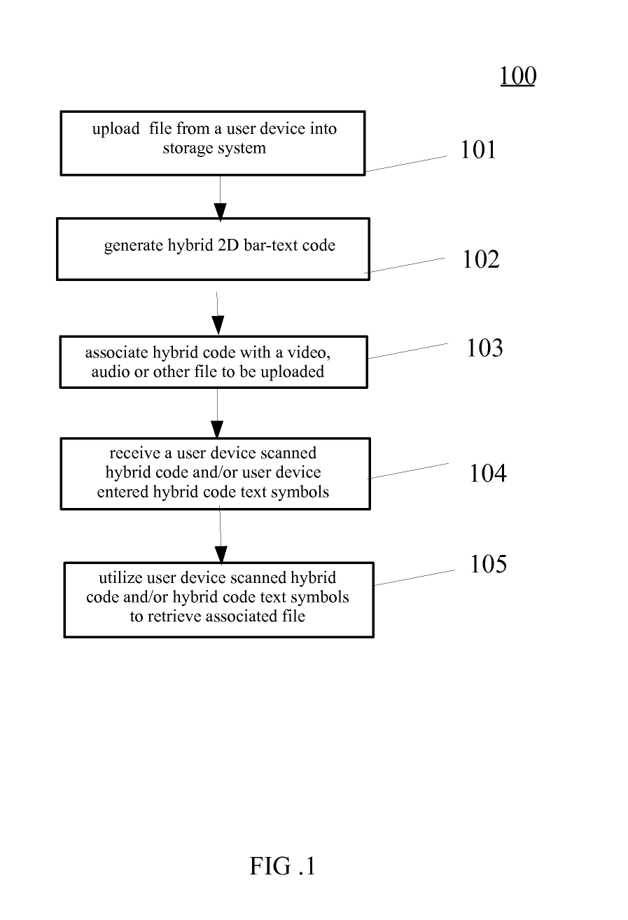

### DETAILED DESCRIPTION AND BEST MODE OF IMPLEMENTATION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

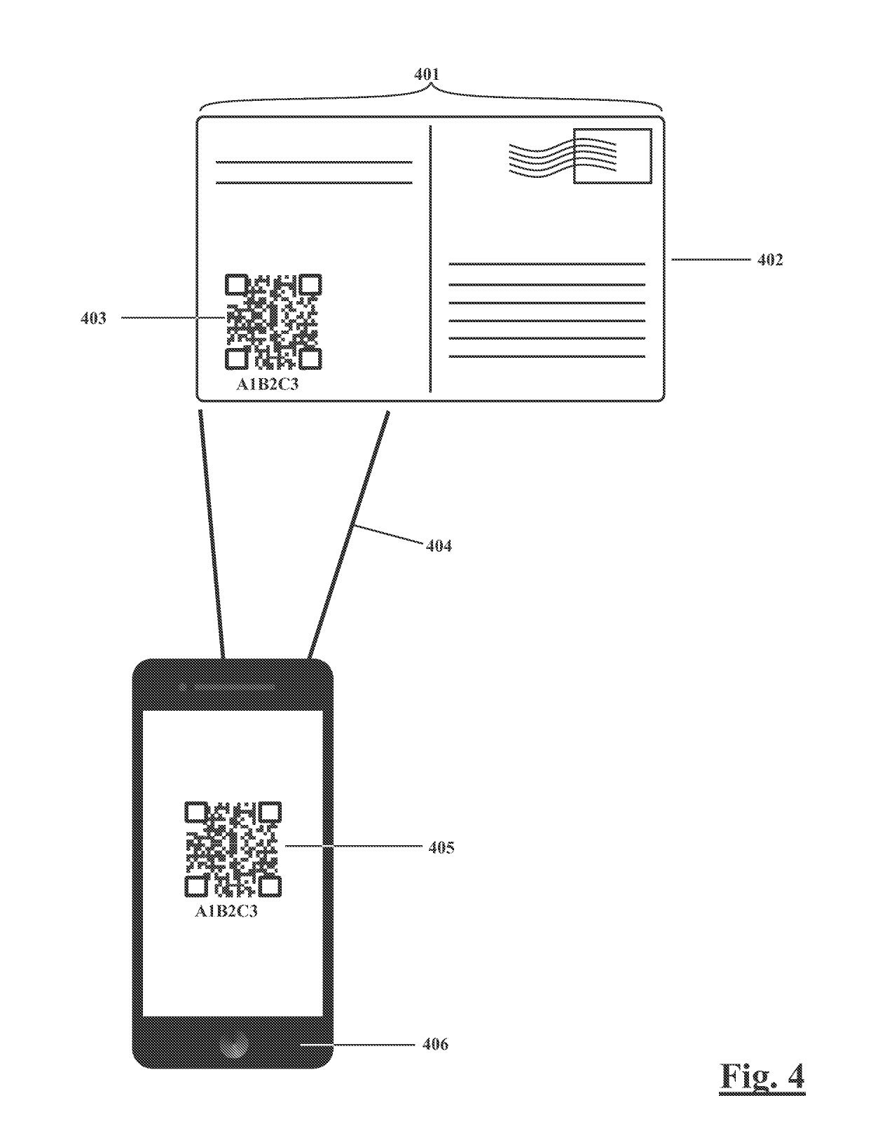

FIG. 4 includes a diagram of a common two-dimensional (2D) barcode 403, which is an available technology that is improved upon according to the preferred embodiment of the present invention. As seen in FIG. 4, 2D barcodes 403 have the potential to store more information by using another axis to store information, whereas historical one-dimensional bar codes are limited only to a horizontal axis.

The most common and frequently used 2D barcode is the barcode symbology referred to as the Quick Response (QR) code, which have been standardized by the International Organization for Standardization. As seen in FIG. 4, the QR code consists of black square dots arranged around a square grid on a white background. Three black and white positioning squares 407 are arranged 3 corners—the top two corners and also the bottom left corner. On the other hand, the bottom right corner of a QR code contains an alignment square 408. Additionally, the three positioning 407 boxes are interconnected by a timing pattern 411. This timing pattern 411 appears as an alternating black and white pixel line that connects each positioning square 407. The positioning squares 407, alignment squares 408, timing pattern 411 provide a means for an electronic device to recognize the QR code and compute the data that is stored by the configuration of black and white dots within the QR code 409. Information encoded in the QR code can be almost any type of data. In one embodiment of the present invention, a QR code may be used to store URL addresses often referred to as hardlinking or object hyperlinking.

QR bar code tag systems do not allow for alpha numeric entry, in other words, a user can only access and create the file by scanning the QR code. By sight alone, a consumer will be unable to input a QR code into a computer. As a result, if a user does not have the QR code, there is no way for the user to access the user files. Such systems are by no means user friendly. Other multi dimensional bar code tag systems also, for example a one dimensional UPC code, require scanning of the barcode to enable files to be accessed.

Technical features described in this application can be used to construct various embodiments of methods and apparatus for mobile tagging or other computer tagging. In one aspect, the present invention system may comprise apparatus configured to perform functionality of the methods of the embodiments described herein. In another aspect, the present invention system may comprise software modules and instructions, which when executed by one or more processors, cause the processors to perform the functionality of the methods of the embodiments described herein.

In one approach, the method for mobile tagging or other computer tagging comprises generating a hybrid 2D bar-text code, wherein generating said hybrid barcode comprises generating a 2D barcode with included text symbols below. FIG. 4 includes an illustration of the preferred embodiments of this component of this present invention 403, referred to in here as a hybrid multi dimensional bar text code. This hybrid barcode 403 contains two components: the first, a 2D bar code 412; the second, a six digit alphanumeric code 413. The method described in this present disclosure further comprises tagging a video, audio or other file with the hybrid multi dimensional bar-text code by associating the generated hybrid code with the file. The method further comprises storing the tagged file for retrieval and retrieving the tagged file utilizing the hybrid multi-dimensional bar-text code.

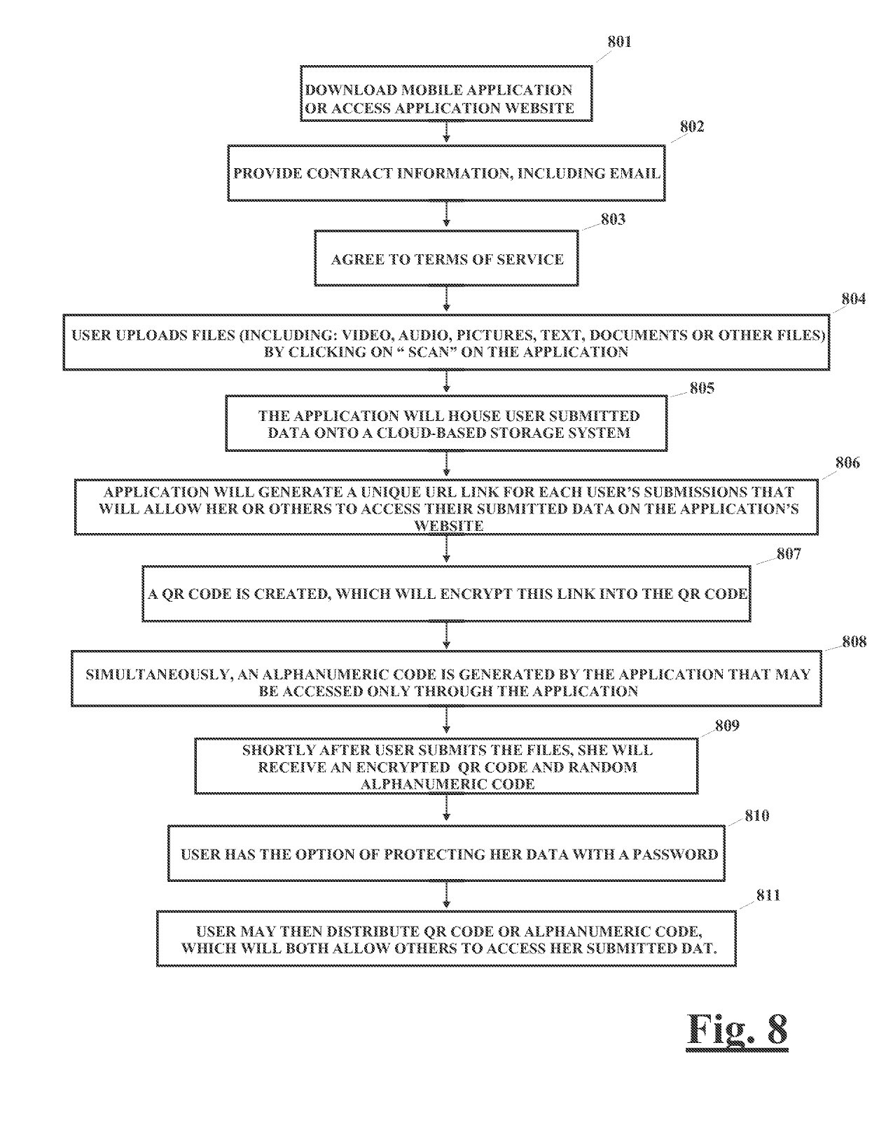

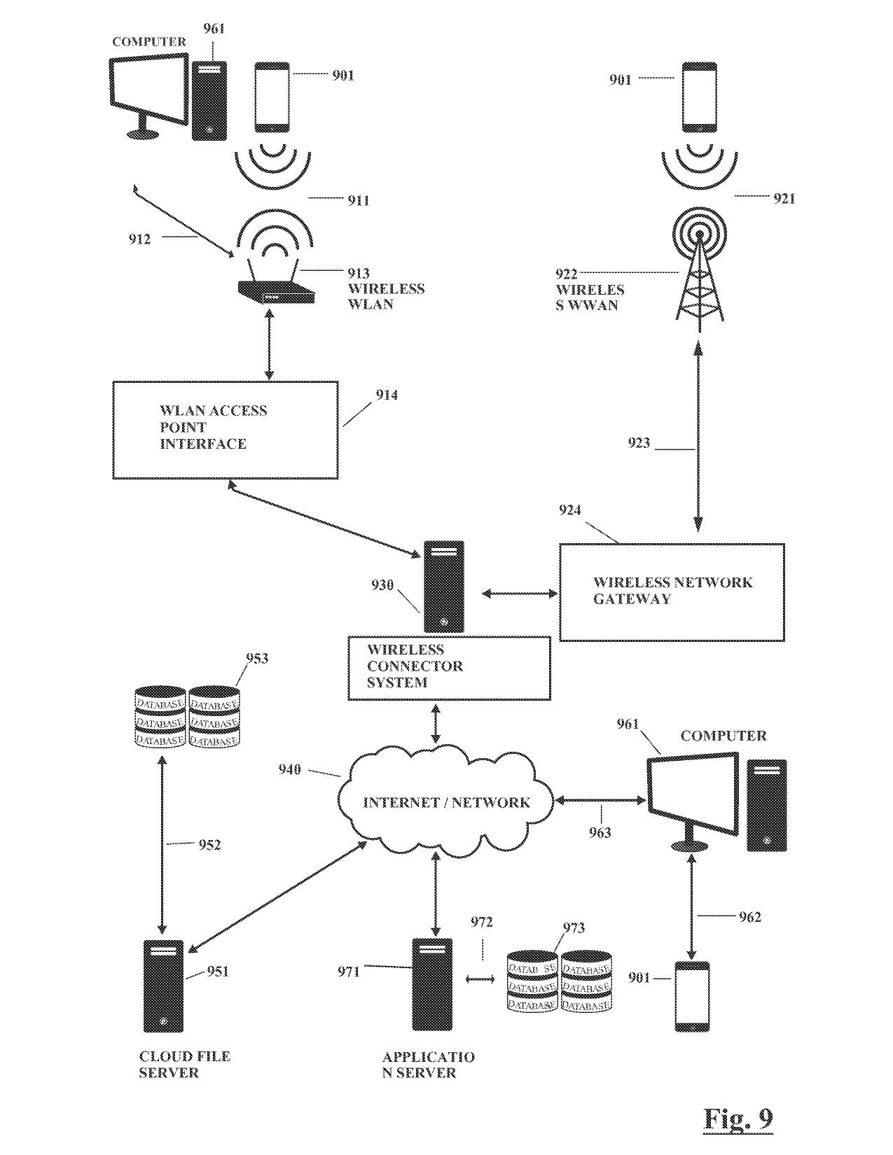

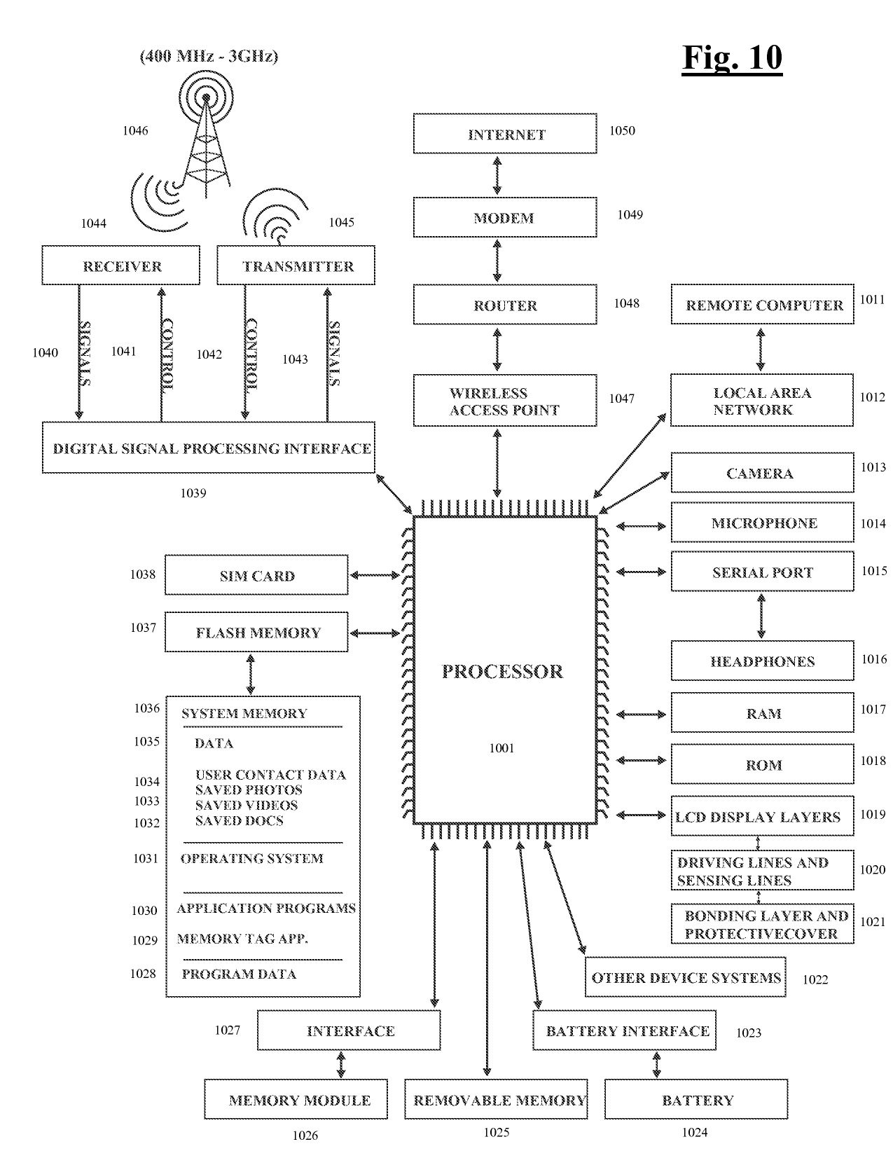

In one embodiment, FIG. 8, Steps 801-811, describe one possible method of both storing user submitted data and secondarily tagging user submitted data to unique hybrid multi dimensional bar text codes. This embodiment uses a mobile phone application program, or alternatively, a computer website. In step 801, the user downloads an application or accesses the application's website. Turning to FIG. 9, the user may download this application from an application server 951 by accessing the internet vis a vis wireless wlan internet 911, wireless wan internet 921, or another type of network connection. Referring back to FIG. 8, the application subsequently requires the new user to complete steps 802-803. The user then initiates the next step of the process, 804, by uploading her file (including, but not limited to: videos, audio, pictures, text, documents or other files) onto the application's servers by clicking a “scan” button or other similar button on the interface. Referring to FIG. 10, which is a block diagram depicting one smartphone to be utilized in the present embodiment, the files may be retrieved from the smart phone's system memory 1036. The user may choose to upload saved photos 1034, saved videos 1033, saved documents 1032 or other files. Alternatively, the user may decide to create a video, picture or audio video using the smart phone's camera 1013 and microphone 1014 features.

Returning to FIG. 8, and continuing the above mentioned preferred embodiment, the application then completes a process described in 805-809 after the user submits a file. First, the application will house user submitted data on to a cloud-based storage system 805. Turning to FIG. 9, one example of how an embodiment may store data is through a cloud file server, 951. The application in this embodiment requires network connectivity through either a Wireless WLAN connection 911, Wireless WWAN connection 922, or alternatively a direct computer connection 961. After a user submits data to the network or internet 940, the user submitted data is then exchanged 952 between the cloud file server 951 and a database 953. Under this present embodiment, such databases may be commercial database providers or a database within the cloud file server. One example of such a third party commercial data base data provider is Amazon or Google. In this present embodiment of a file storage system, the user's save data is also stored in the cloud based storage system and associated with the unique 2D code, alphanumeric code and URL associated with the image. In this present embodiment, data is stored on the application's cloud file server for an infinite period of time or until the application's system administrator or the user decide to remove stored data.

Referring to FIG. 8, and continuing the above mentioned preferred embodiment, the application will next tag a unique URL link to the submitted file 806. Turning to FIG. 9, this process may be completed by one possible configuration of this present invention on the application server 971. In one example of this present invention, the URL link is created on the application server 971, by combining unique pre-generated codes stored on the application server's database 973. In this example the function of the URL links will be preferably to tag or associate user submitted data with a unique URL link. The described generated URL link will also be tagged with and associated with the user's submitted data, which is stored through the cloud file server 951 and located on the cloud file server.

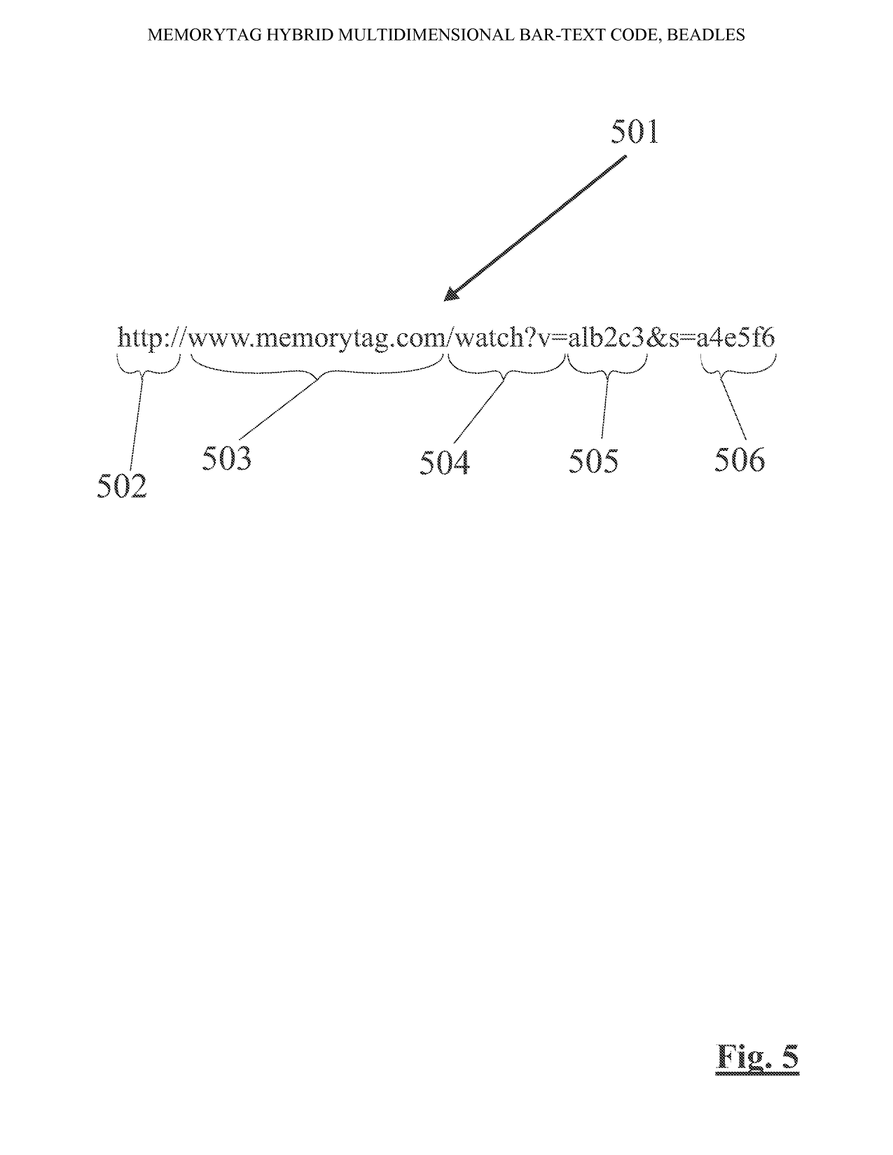

Referring to FIG. 5, which is a specific text image of this present invention, one example of URL links generated in one embodiment of this present invention is seen in the text image shown in 501. This entire URL 501, includes a hyper text transfer protocol component 502, and a website address 503 that refers to a host name or the name of the website's server. This URL 501 also includes a component that will allow the user to hear audio, see videos or view documents based on an embedded player within the website 504. An example command to view videos may be ‘watch?v=’ as seen in 504. Further, the last part of the URL link 501 generated by this present embodiments preferably contains two parts, a short code 505 and a security code 506. In FIG. 5, the short code 505 is “a1b2c3” and the security code 506 is “d4e5f6.” Each short code 505 has been pre-generated and the codes are stored in the application's database to ensure duplicity does not occur. For each piece of data stored onto the cloud server database, a unique short code shall be generated, associated or tagged on the application server. The security code 506, on the other hand, ideally performs one or more beneficial functions. In one example, the security code is used to ensure that the user possesses the associated 2D tag or alphanumeric code. In another example, the security code may be associated with an optional password entered in by the user after the user submits their video. Turning to FIG. 9, once a unique short code and security code have been generated the URL is complete and will be communicated 972 back to the sever 971 and in turn sent back to the user via the internet 940. The URL link will also be communicated to the application's cloud file server 951 where it is stored alongside the user's submitted data on the database 953. The method described in this step of the present embodiment is just one of many ways of doing this, and the present invention may be practiced in other embodiments which depart from the specifics set forth in this present disclosure.

Referring back to FIG. 8, and continuing with the above described embodiment, the application continues the process of tagging the user's submitted data by associating it with a generated 2D code 807. Using available technology, the generated 2D code will link and tag to the unique URL link generated in the prior step, 806. In one embodiment, each generated 2D code directly links, by use of a URL, to user submitted data stored on the application's sever. To further this association, the 2D code 807 is also associated alongside the saved data previously submitted, 804-805, by saving the 2D code alongside submitted data in cloud file server's database. Next, the application will generate an alphanumeric code, 808, which will be shown directly below the 2D code (previously generated in 807). Preferably, in one embodiment, the alpha numeric code generated in step 808 will correspond to the short code described in step 806. This association is also saved and stored in the application's database (not pictured).

Still referring to FIG. 8, and continuing with the above described embodiment, preferably, after the application has performed it's process of tagging user submitted data and saving this association in the database 806-808, the application will send back a message to the user to confirm that the data has been successfully stored (not pictured). The application or website, in this embodiment, will then display a copy of the 2D code and alphanumeric number 809. The application may deliver this unique saved 2D code and alpha numeric code 809 by: email addresses provided by the user in 802, through on on-screen displayed image, or by saving the data in the user's account under previously submitted files or a variety of other methods. The user may then choose to print the generated 2D code and alphanumeric code and attach it to the associated text. The user then will have the option, through the application, of protecting data from others to assess with a unique password 810. Other options or capabilities the present embodiment of this invention may have is to allow the user to add a title description, share the data with social media websites or upload additional files 810. After these steps are completed, the user may then distribute the hybrid multi dimensional bar text code generated in 805-808 to others, which will allow them to access her submitted data through the use of a smartphone or home computer. Through the steps disclosed in FIG. 8, the user's data is stored onto a cloud based file server and tagged with the multidimensional bar text code of this present invention.

Embodiments may be practiced in many different methods. One example, the present invention may be used by an entity, business or group in conjunction with mass produced advertisements, such as but not limited to flyers, posters, brochures, pamphlets, business cards, magazine advertisements, newspaper advertisements, display racks, invitations and the like by including 2D Codes and alphanumeric codes generated by the present invention onto printed advertisements. In another example of this present invention, unique previously generated hybrid multi dimensional bar text codes may be pre-printed on to postcards, birthday cards, picture frames, special event cards, ecards, invitations, announcements, stationary and the like for the user to supplement with their own videos. In this embodiment, involving regenerated hybrid multi dimensional bar text codes, the processes of associating submitted images, videos, or other files may take different steps but still fall within the disclosures of this present invention.

Embodiments may be practiced in many different environments. By way of example, the memory tag hybrid multidimensional bar-text code system of embodiments may be implemented on at least one network server site in conjunction with at least one user processor apparatus, such as but not limited to video camera devices; mobile telephone devices; smart phone devices; tablet devices, portable processor devices; personal computer (PC) devices; surveillance devices. The network server site (see for example website server of FIG. 9) may be provided within a network which, for preference, is the Internet, but equally can be any one of, combination of, or interconnection of, but not restricted to: a local area network (LAN); a wide area network (WWAN): a home network; and a wireless network. The user processor apparatus communicates with the network server site over a telecommunication network and/or internet etc.

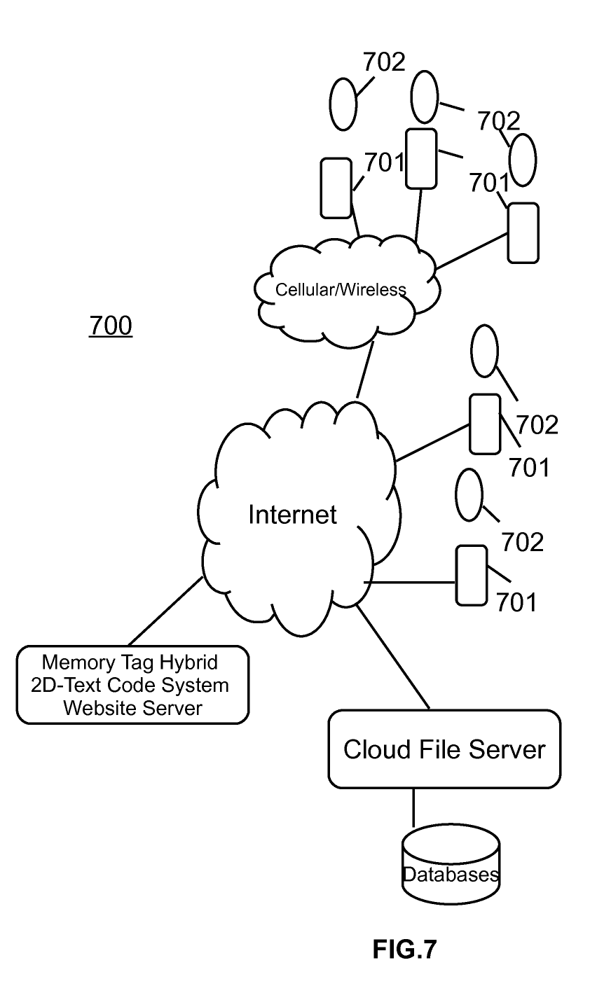

A non-limiting exemplary schematic diagram of one of many such different environments wherein the embodiments of the memory tag systems and methods may be practiced is depicted in FIG. 7. A cellular telecommunication network, and/or internet, interconnects user devices 701 and the memory tag system website server. A cloud file server and database stores files uploaded in response to the website server receiving instructions from users 702 via user devices 701. A database (not shown) stores generated hybrid codes for access by the system. The memory tag system associates the files with hybrid codes.

The non-limiting specific exemplary schematic diagram of one of many such different network environments wherein the embodiments of the memory tag systems and methods described in this present disclosure may be practiced is depicted in FIG. 9. FIG. 9 describes the various different methods that a user of this present invention may connect to network or internet 940, through either an internet capable smart phone 901, or an internet capable personal computer 961. The first method described method in this specific exemplary diagram that a computer or smart phone may use to connect to the internet is through a local area network (LAN) connection 963. The computer, 961, connects a networking cable into the network 940. The smart phone 901 my too connect to the network 940 by directly connecting into the computer 961 through a networking connection 962. Turning to FIG. 10, this connection is made possible by the processor 1001, which is connected to a Local Area Network 1012 connected to a remote computer 1011. Turning back to FIG. 9, although the LAN connection described in 962-963 may be currently unavailable for the internet, it remains a feasible alternative use of this present invention in one embodiment.

A second example of a non-limiting exemplary diagram of one of many such network environments is further seen in FIG. 9. 911-914 demonstrate how a computer 961 or smart phone 901 may connect wirelessly or wired into a wireless WLAN system 913. First, the smart phone or computer must have an installed wireless card or wireless compatibility, and then it connects through the Wireless LAN device wirelessly 911 and 912. Alternatively, the computer or smart phone may connect to the wireless WLAN system through an Ethernet cable, 912. Next, the wireless WLAN device connects to a WLAN access point interface 914. Instead of a WLAN access point interface 914, it is feasible that some network systems will have a wireless network gateway 924, with integrated firewalls. After, the system connects to a wireless connector system, 930. If this wireless systems connector 914 is to be connected to the internet, the wireless systems connector must connect to an internet service provider (not shown) before the user may access the internet. This wireless system device is capable of connecting into the internet or designed network, 940. A third example of a non-limiting exemplary diagram of one of the many such network environments is shown in FIGS. 9, 921-924 and 930. This third example is based on a wireless wide area network (WWAN) connection, commonly used by smart phones and mobile technology networks. Non-limiting examples of currently WWAN providers include: T-Mobile, Sprint, Verizon, MetroPCS, and AT&T. First, the smart phone or feasibly a computer would transmit a signal to the Wireless WWAN receiver or tower 921. The signal then would be transmitted 923 to the Wireless Network Gateway 924 of the WWAN internet service provider. The WWAN internet service provider, after authentication, authorization or any similar process, then will transport the signal to a wireless connector system, 930 which will connect directly to the internet or network 940.

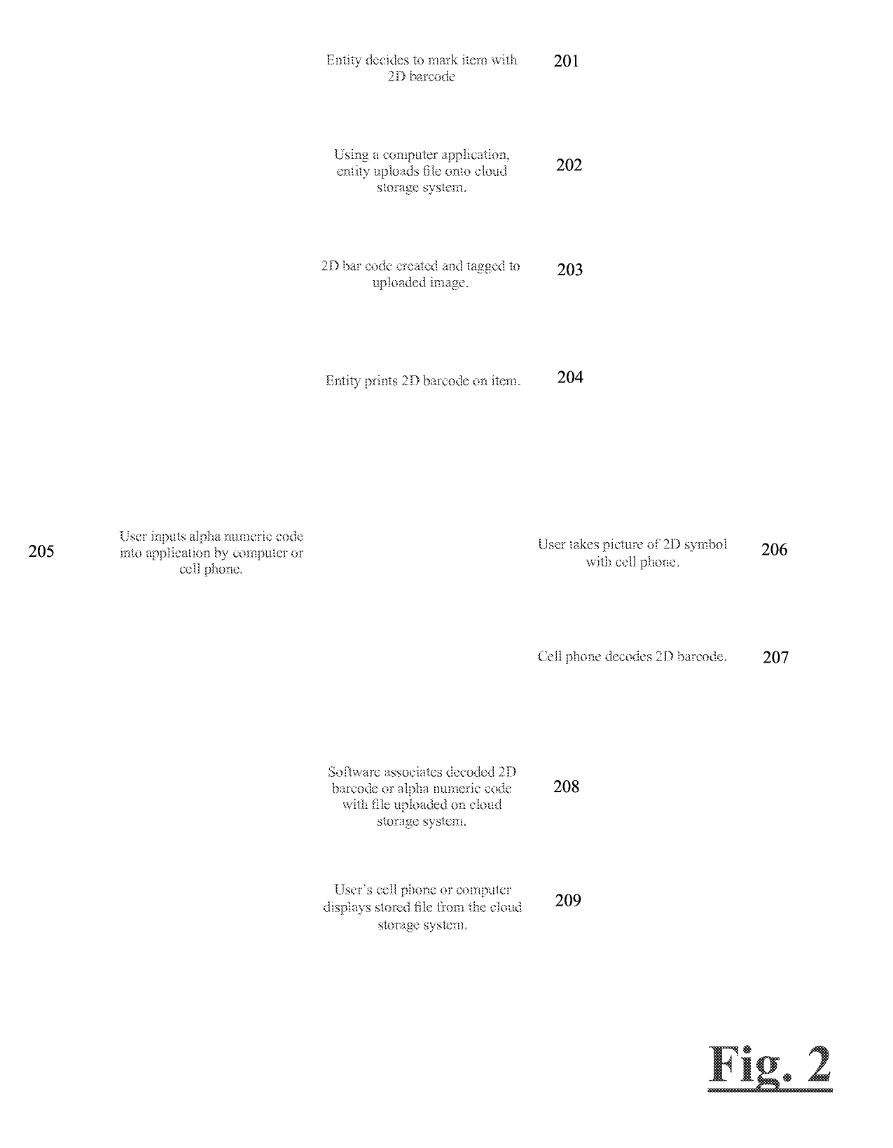

Continuing with FIG. 2, in an exemplary embodiment of the present design, steps 201-204 describe the process that an entity or individual will use to tag a published advertisement, text, postcard or the like with an associated file (including: audio, video, text, or other file) with a hybrid multi dimensional bar text code that is printed on the media. Steps 205-209 describe the process that a user, who has received a published advertisement, to retrieve the associated file by inputting either the 2D Code or alpha numeric code into a cell phone or computer. First, an entity will decide to mark an item or piece of data using the application described in this present invention. Unique hybrid multi dimensional bar text codes are stored in the system's cloud server 201 and the entity will then print the hybrid multi dimensional bar text code onto the item 202. Then, using an embodiment of an application of this present invention, the entity will upload that file 203 onto the cloud storage database maintained by the application. The file uploaded by the entity 203 will become tagged and associated with both the 2D bar code and text code on the printed advertisement 204. Now, turning to the user, she will first receive the advertisement or other text prepared by the entity with an included hybrid multi dimensional bar text code. Next, a user will have an option to either: input the printed alphanumeric number into an application 205; or, alternatively, the user may take a picture of the 2D Code 206 which will be automatically decoded by her cell phone 207. Using either method, the user will reach the application website where she will be able to access the data tagged by the 2D code or alphanumeric code 208. The data, having been uploaded previously, would have been stored on the application's cloud file database and made available by the cloud server. Finally, the application displays the stored information on the user's smart phone or computer 209.

In one example of this embodiment, an artist decides to promote their new album by publishing a band poster. Using the present invention, they are able to associate a sound file stored on a cloud based server with a hybrid multi dimensional bar text code. This hybrid multi dimensional bar text code, which is associated with the artist's top music track, appears is printed onto the artist's band poster. A user, who is interested in hearing the artist's track after seeing the album poster, is able to hear the stored music file by input the 2D Code or alphanumeric code into her smart phone or computer.

In another example, the application software configures hybrid multi dimensional bar text code into printable files which are provided to the user device to enable the user to print off the hybrid 2D text code onto individual labels or directly print or attach to end products. The user can place the code on anything and have details for it. By way of non-limiting example, for a greeting card, a user can record a personal video message to their special someone using their smart phone and associate the video message file to an hybrid multi dimensional bar text code using the application of the present invention. The user can simply print off the code onto an adhesive backed label and and stick the hybrid multi dimensional bar text code label on the greeting card. When the recipient gets the card, the recipient can use their smart phone or pc and the memory tag system to view the video message from the giver by scanning the code on the greeting card. In another non-limiting example, the user can stick the hybrid multi dimensional bar text code on a picture and upload a video or audio message describing the picture. Anyone who scans the 2D code or types in the alpha numeric code can listen or watch the person tell them what the picture is about. In another example, the barcode is pre-printed on post cards previously and the user simply has to associate a video message to the barcodes and alphanumeric codes.

The memory tag hybrid multidimensional bar-text code apparatus and methods of some embodiments capture different data and uses different databases. In one example, the hybrid 2D code uses both alpha and numeric and even symbols to further allow ease of use and protection for the user. The hybrid 2D codes while being generated capture the users name, phone, address and email a copy to the user for later usage or records in case of loss. The files are stored for an eternity where others only for 20 to a100 years. The system can be used by anyone with a simple skill set to create and share their own personal messages for any occasion for any medium.

In one example, the software application is configured to create an infinite amount of hybrid 2D codes that have alpha-numeric and even symbols then stores them in a database to be assigned to future users. The software application for generating and assigning the codes, for upload and storing the files and recording information work in harmony together capturing and storing all data, statistics stc.

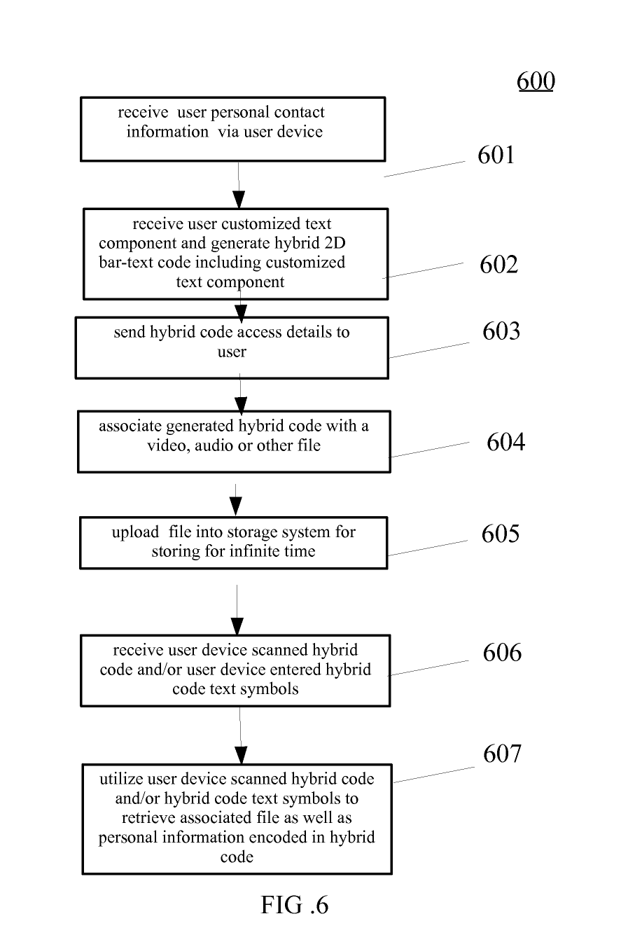

In yet another example, the software application is configured to enable the user device, under control of the user, to design and customize the hybrid multidimensional bar-text code that is to be associated with the uploaded file. FIG. 6 is a flow chart outlining a method for mobile tagging according to one such example. In one non-limiting example, the software is configured to enable the user to utilize the user device to decide on the text component of the hybrid multidimensional bar-text code. In this manner, the user can enter via the user device a particular text code, e.g. alphanumeric and even symbols, that is easy to memorize. In another example, the user can operate the user device to select from some options that are easier to memorize. The software application generates a hybrid multidimensional bar-text code in which the text component corresponds to the user entered or selected code.

Turning now to FIG. 10, which represents an exemplary example of one of the many configurations of a camera enabled smart phone which may be used for the present invention. FIG. 1047-1050 represents another non-limiting example of a possible configuration of a WLAN internet or network connection this present invention may be connected to. Next, FIG. 1039, 1040-1046 show another non-limiting example of a WWAN internet/network connection. Finally, 1012-1011 show a direct LAN connection for the present invention. All three alternatives are connected to a central processor 1001, where data is processed through commands and instructions.

Remaining on FIG. 10, non-limiting example smart phone configurations aimed to store data are shown in 1028-1036. A typical smart phone stores saved information on a flash memory card 1037, although other methods are feasible. The application, or similar application of this present invention is stored at 1029 under application portion 1030 of the system's memory 1036. The data portion 1035 stores saved data, including: contact data, saved photos 1034, saved videos 1033, saved documents 1032 as well as other saved files. Also saved is the operating system 1031 and program data 1028. Although not to common, alternative designs may feasibly store saved photos, videos, or documents by using a sim card 1038, rom memory 1018, ram memory 1017, or removable memory 1025.

Remaining on FIG. 10, non-limiting examples of smart phone configurations that enable a user to input 2D codes or alphanumeric codes of this present invention are shown in 1019-1021 and 1013. The camera component of a smart phone 1013 may be used to take a picture of a printed 2D Code of this sample invention. Once user has captured a 2D code with the camera 1013, the information is relayed to the processor 1001 and another running application such as the operating system 1031 recognizes the 2D Code of this present invention. The operating system 1031 then will open either an internet browser 1030 or launch the memory tag application 1029, if installed. This process allows the user the file associated with the 2D Code. Alternatively, a user may use 1019-1021 to input an alpha numeric code using a smart phone's touch screen. First, the user will be shown an on screen keyboard display 1019, and will then manually input the alphanumeric code of this present invention. Driving and sensing lines 1020, will sense the user's manually inputted alpha numeric code, and relay the information to the processor 1001 who will check for errors. A bonding layer and protective outer glass cover 1021 encase the two layers described 1019 and 1020, so a user's touch will not destroy the phone. The inputted alphanumeric code will then retrieve the stored tagged file associated with the alphanumeric code.

In one example, the process of retrieving the tagged file utilizing the hybrid multi dimensional bar-text code may be implemented by scanning the multidimensional bar component of the hybrid code using the user device (mobile, PC, etc.) as the scanner, decoding the hybrid code and using the decoded contents to look up and retrieve the file associated with the hybrid code. In one example, the multidimensional bar component is a two dimensional barcode. For example the two dimensional bar code may be a 2D code. In another example, the component may be a datamatrix. In another example, the multidimensional bar component is a three dimensional bar code.

In another example, the user may optionally enter, via the user device, the text component of the hybrid code, that is, the characters, alpha, numeric, and/or symbols etc. of the text code included in the hybrid multi dimensional code. Text is used herein to mean any characters, alpha, numeric etc. or symbols that can be entered through texting operations on the mobile user device. ABCD123!@# is an example of such text. The tag system then utilizes the text component to enable the user to look up and retrieve the file associated with the hybrid code.

In one approach, a simple smartphone or PC downloads an application that allows the user to create their own personal audio or video message. The software then assigns hybrid multi dimensional bar text code to their file, the file is then stored for eternity. This personal message can be something as simple as a grocery reminder to a special message to a loved one on a greeting card.

FIG. 4 depicts an illustrative example of one method of using one embodiment of this present invention. 401 shows a post card sent by a friend or associate and delivered to the user of this present invention 402. This post card 401 contains 402, but also one embodiment of the hybrid multi dimensional bar text code of this present invention 403. The 2D Code and alphanumeric code 403 is affixed to this postcard by tape, a sticker, glue, printed or has been previously preprinted on the post card. The user, who is interested in supplementing the text of the post card with the video embedded in the code, uses a smart phone 406, through its camera function 413, to capture an image of the hybrid multi dimensional bar text code of this present invention 404. By this process, the user's phone will immediately recognize the 2D tag and grant the user access to the data associated with the 2D tag.

The hybrid 2D code allows the user to scan the hybird 2D code or go directly to the application website and type in their alpha numeric and symbol code (text code) to view the files. Unlike known tag systems in which lose of the 2D code results in the user never being able to recover the data, the app and software of one or more embodiments captures the users name, phone#, email address and sends them confirmation codes to view and use the 2D code in the case they lose or misplace the physical 2D code to scan or use the alpha numeric symbol code. It allows people to create a scannable and alpha numeric 2D code personal video or audio file that's easy for anyone to create or view.

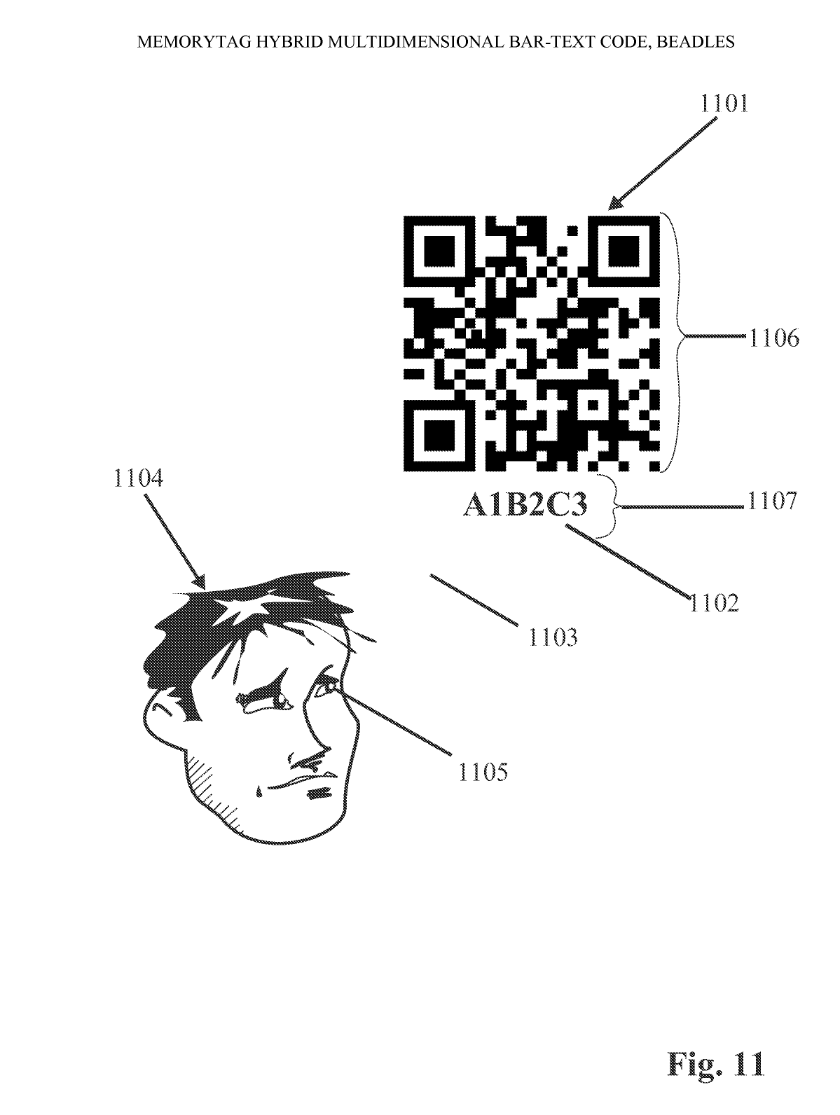

FIG. 11 depicts an illustrative example of one method of using one embodiment of this present invention. 1101 shows the hybrid multi dimensional bar text code of this present invention, affixed to a text that a user 1104 wants to supplement. The 2D code and alpha numeric code 1101, contains two parts: first, the 2D Code 1106, and second, the alphanumeric code 1107. The user 1104, who does not have a smart phone will find it very difficult to input the 2D Code 1106 into any machine. However, the user 1104, can easily recognize the alphanumeric code 1107. Using a user's 1104 eyes 1105, the user simply has to look 1103 at the alphanumeric code 1102 to process this information. Through the online application, either by cell phone or internet, the user 1104 will input the alphanumeric code 1102 that he recovered by vision 1103 into the application. The application, in turn will retrieve the stored data and show present it to the user.

Software and apps from smartphone or pc create a unique, scannable, 2D code with alpha numeric functionality that allows the user to create, share and view a video or audio file, safely stored and accessible for eternity, viewable and accessible from PC or smartphone.

In one example, the system retrieves the file associated with a hybrid code by using the text component, e.g. the alphanumeric code, of the hybrid code to first retrieve the hybrid code in a database or other storage area. The file associated with the hybrid code can then be accessed using the retrieved hybrid code.

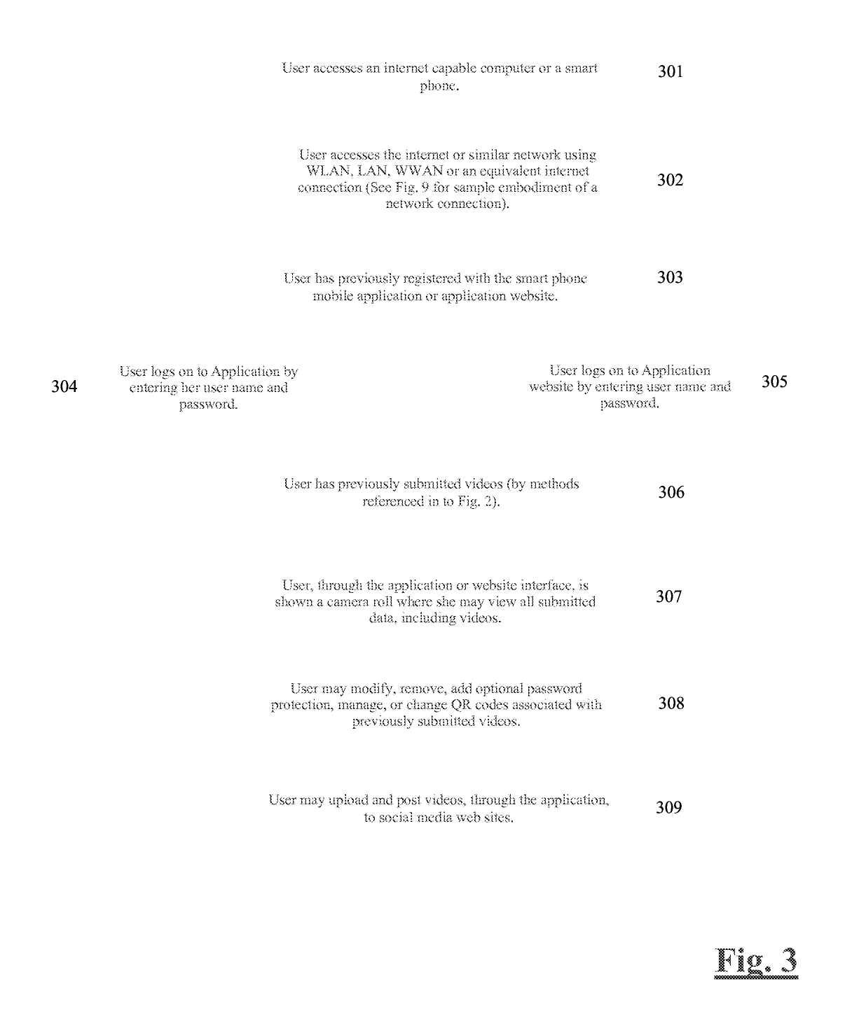

Turning now to FIG. 3, FIG. 3 is an example of one embodiment of this present invention that involves the application of this present invention. Through the use of the application, a user may manage uploaded files and the user may also modify each associated file's 2D Code and alphanumeric code. Steps 301-305 describe the process by which a user will log on the application. First, the user accesses an internet capable smart phone or computer 301. Next, the user will access the internet 302. After, the user will access the mobile application or the application's website 303. A user who has not accessed the mobile application on their internet-capable smart phone may download the application through the internet and register the application (not shown). A user who has previously accessed the application on their internet-capable smart phone will have to log on to the application with her unique username and password 304. Any user may access the application's website and simply manually input the alpha numeric code 305 that the file is associated with. If a video or other file is password protected, under this present embodiment of this present invention, the user must enter the password 306. A prior user, who has already uploaded videos, will then be shown an interface where her submitted videos are stored 307. In this interface, the user may decide to add additional videos either recorded at that time or stored in the device she is using. She then may modify files, remove files, add password protection, change associated hybrid multi dimensional bar text codes through the interface 308. Another option the user has is to post videos or other files onto social media websites 309. One example of a method of sharing the user's submitted videos with a social media website 309 would include removing the security code generated by the URL link through the application's server and allowing social media users to access the video by an embedded player. The user's management options of previously submitted files are by no means exhaustive nor are the methods exhaustive.

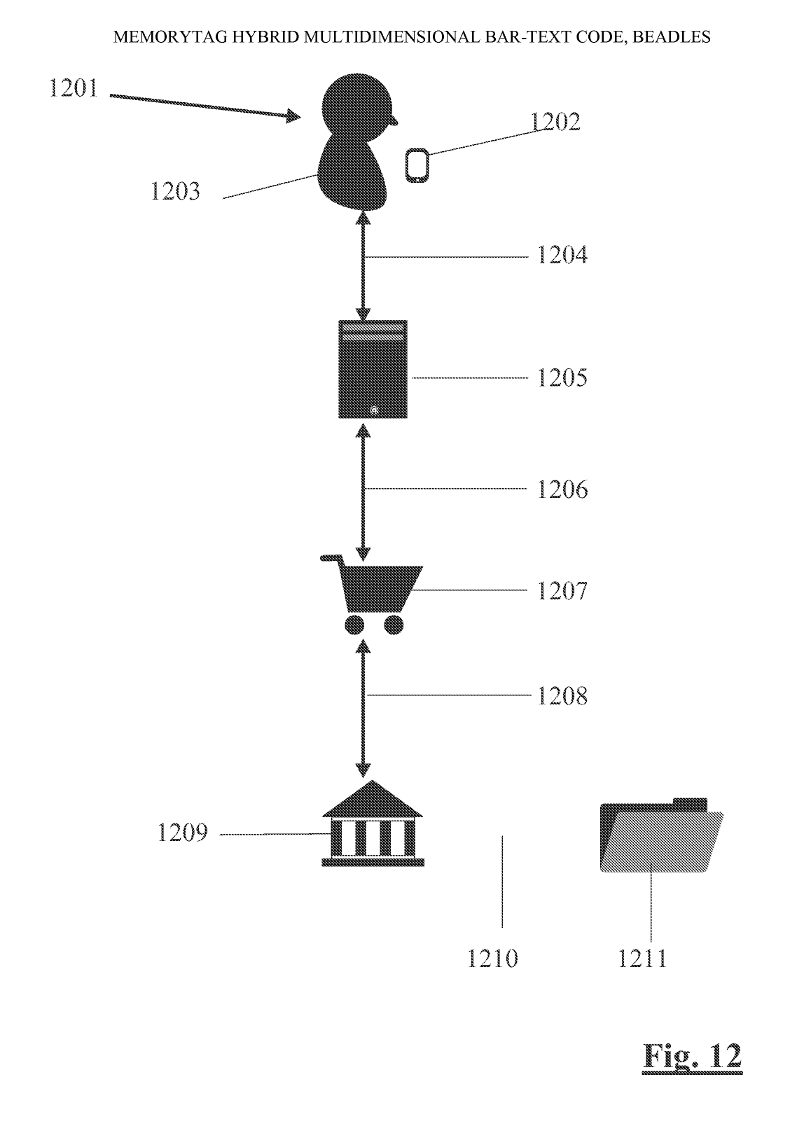

FIG. 12 is a block diagram illustrating one of the various ways of online merchant processing available for this present invention. According to one embodiment of this present invention, a user of this application may be changed a small annual or monthly fee in order to upload, tag and store files onto the application's server and data base. Turning to FIG. 12, the user 1203 has obtained an internet capable smart phone or computer 1202. The user, through his smart phone, 1201 will agree to the terms of use of the application provide the application with payment information and agree to a subscription. This order, in turn, is transmitted 1204 to the application's server 1205. The application's server will then make a request 1206 to the payment gateway 1207. Nonlimiting examples of some payment gateways include authorize.net. Next, the payment gateway 1207 will make a request for confirmation 1208 to the user's bank 1209. The user's bank then will respond 1208 to the payment gateway. This response 1208 is communicated 1206 back to the application's server 1205 by the payment gateway 1207. The application's server will then respond 1204 to the user subscribing to the application 1201. If the application user's 1201 bank 1029 has authorized the request for confirmation 1208, the user will have successfully subscribed to the application for a monthly or yearly basis and the user's bank 1209 next will transfer funds 1210 to the application's merchant account 1211. However, if the user's bank 1209 has not authorized the request 1208, the user 1201 will have to submit a new order 1204 and start this process all over again until a favorable response is secured by the bank.

In another embodiment of this present invention, users who upload, store and retrieve photos, videos, or other files using the application system of this present invention are not charged a monthly or yearly subscription. Under this present embodiment, the application is free to use, but there will be advertisements provided by third party advertisement companies. Each advertisement may appear somewhere in the interface of the present invention or website by a video, photo or audio file. Advertisers will support the application by remitting payments to the application's merchant account based on the amounts of advertisements transmitted, amount of advertisements clicked or other calculations the advertiser agrees to. In another embodiment, a user may agree to a subscription, as seen in FIG. 12, in exchange for the application removing advertisements.

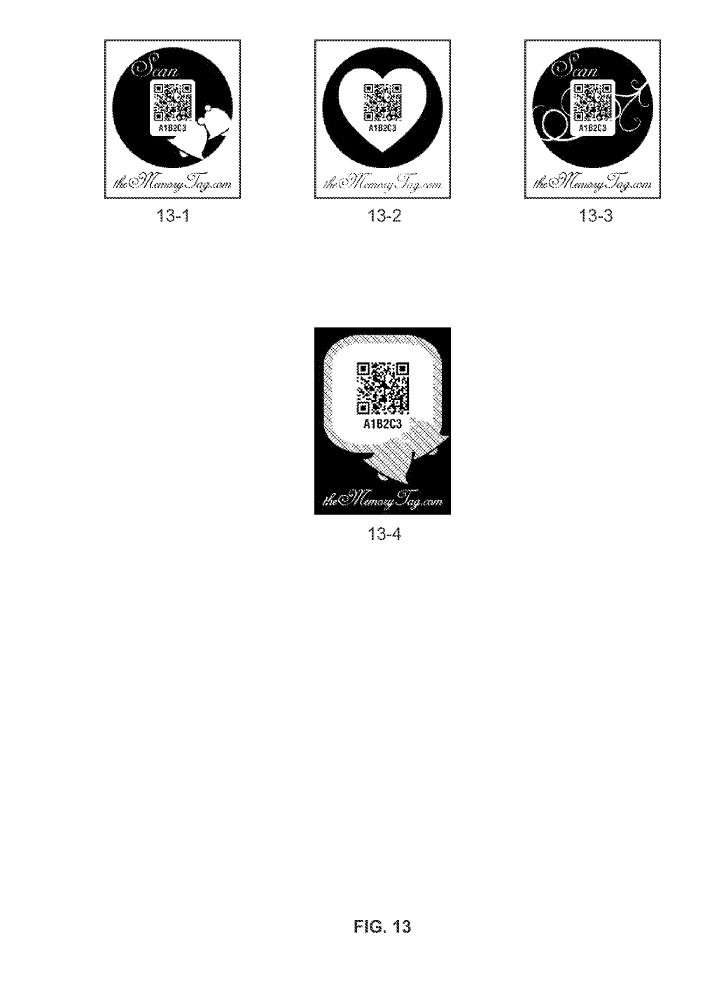

In another embodiment of this present invention, examples of momentos are provided utilizing this present invention involving the use of a hybrid multi dimensional bar text code. FIG. 13 is a chart of various types of sticker/seal-type momentos that users may use to stick onto invitations or envelopes for wedding invitations, for example, to provide invitees with access to extra information as discussed previously, where the present invention includes a convenient and easy storage system for users to submit their own video, audio or other files. One embodiment includes a cloud based file storage system where submitted files will be housed and linked with their tagged associated URL, 2d bar code and alphanumeric bar codes. In one embodiment, the user has the option to password protect their submitted files.

These seal momentos can be used for various holidays, including, but not limited to wedding invitations (13-1, 13-4), Valentine's day (13-2) or anniversary celebrations (13-2), or other celebrations such as birth announcements (13-3), all of which may be used for other purposes as the user deems fit.

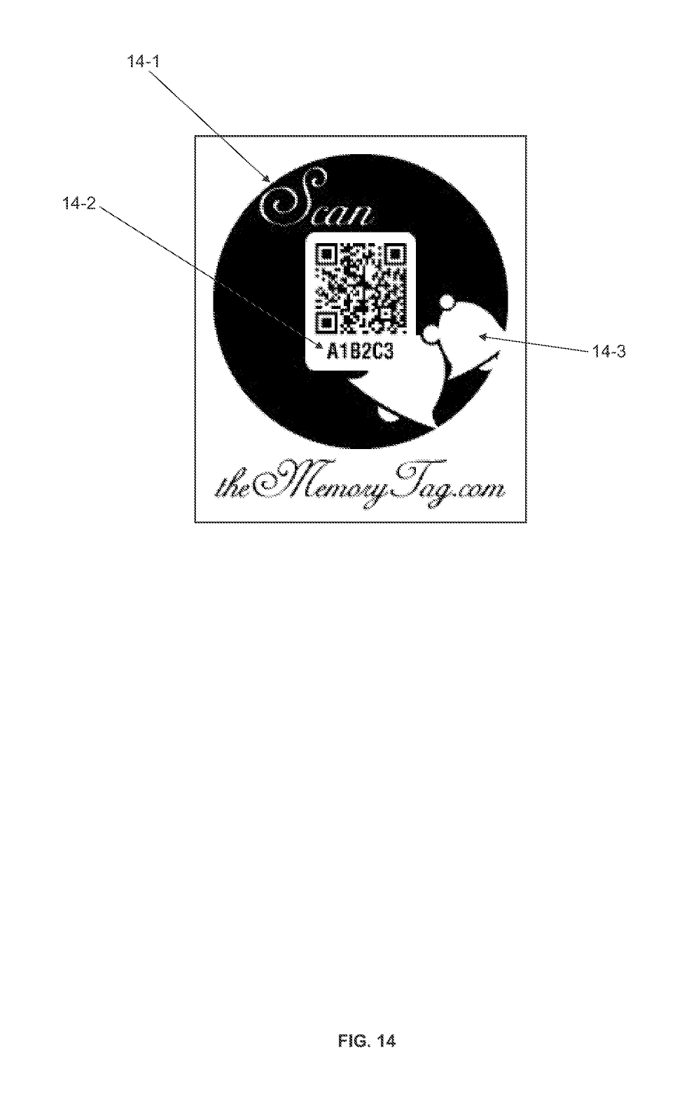

In another embodiment of this present invention FIG. 14 is an illustrative example of a momento, where an area for descriptive text is available (14-1), some icon or symbol for the celebration is imprinted or otherwise visible (14-3), and is shown using this present invention involving the use of a hybrid multi dimensional bar text code (14-2).

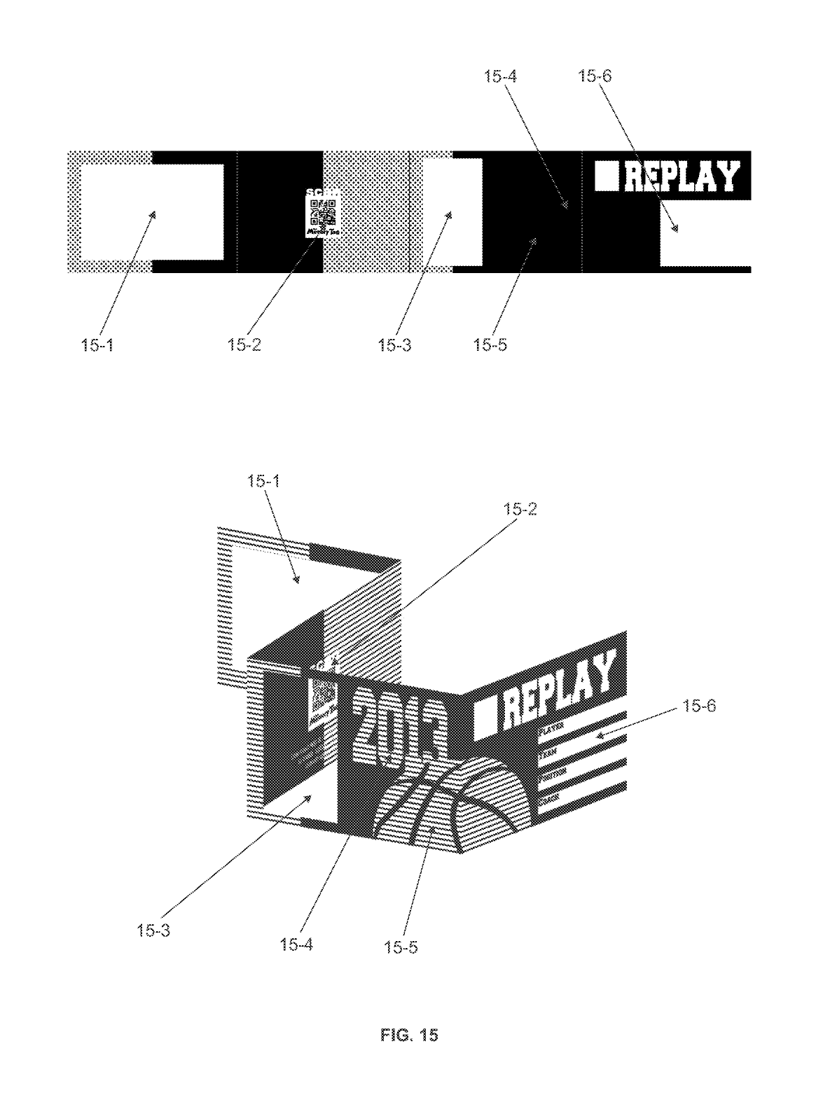

In another embodiment of this present invention, FIG. 15 is an illustrative example of momento that can be used to hold or showcase pictures or player stats (15-1, 15-3) related to events, in particular and non limiting example with youth sporting teams, where information regarding the player, team, position, coach, year (15-6), can be imprinted or otherwise made visible onto the momento (15-1 through 15-6), further using this present invention involving the use of a hybrid multi dimensional bar text code with corresponding area 13-2. Logos of each respective sport may be placed at 15-5 and season year at 15-4.

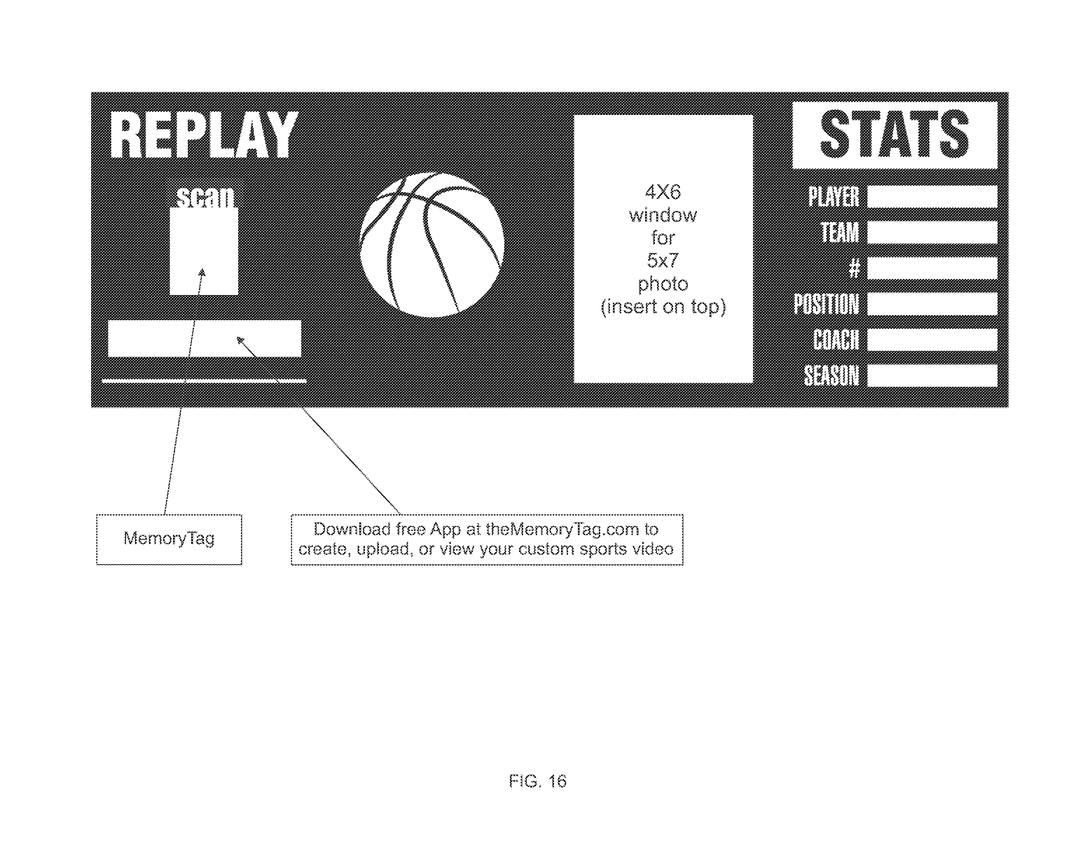

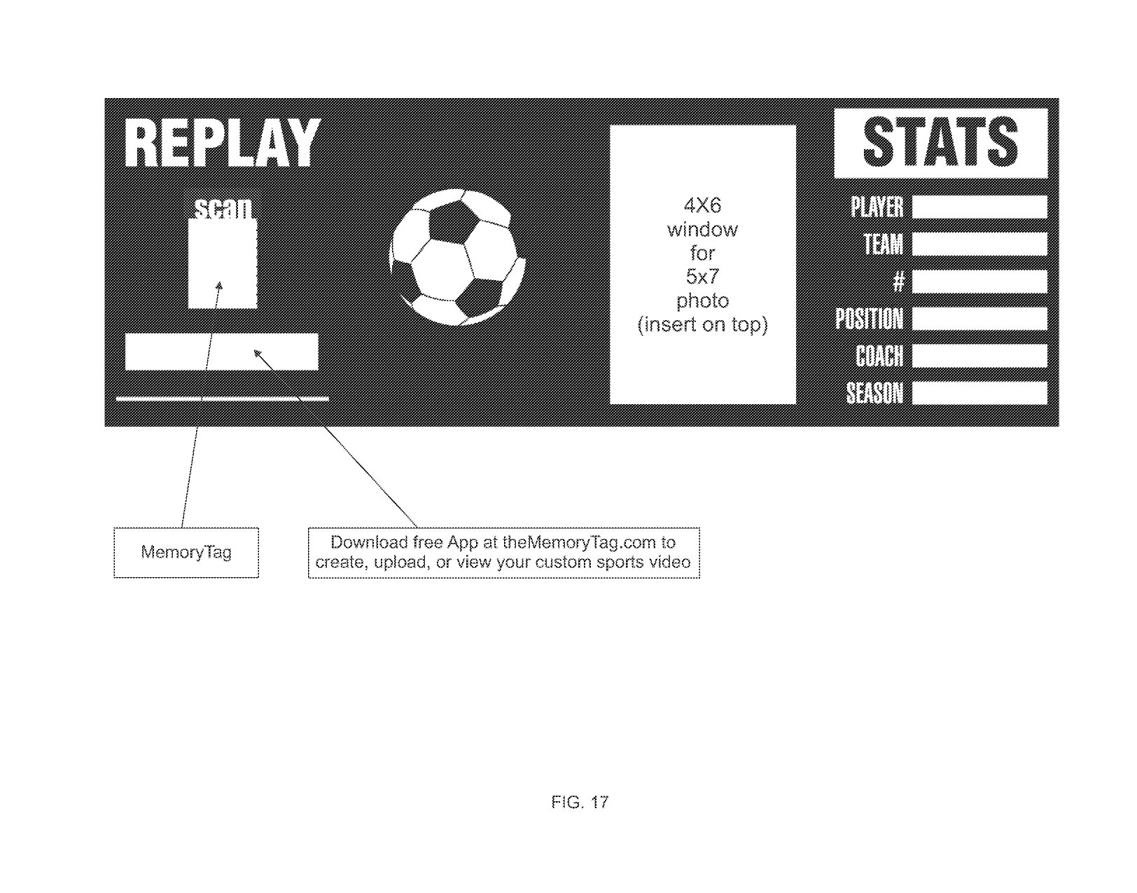

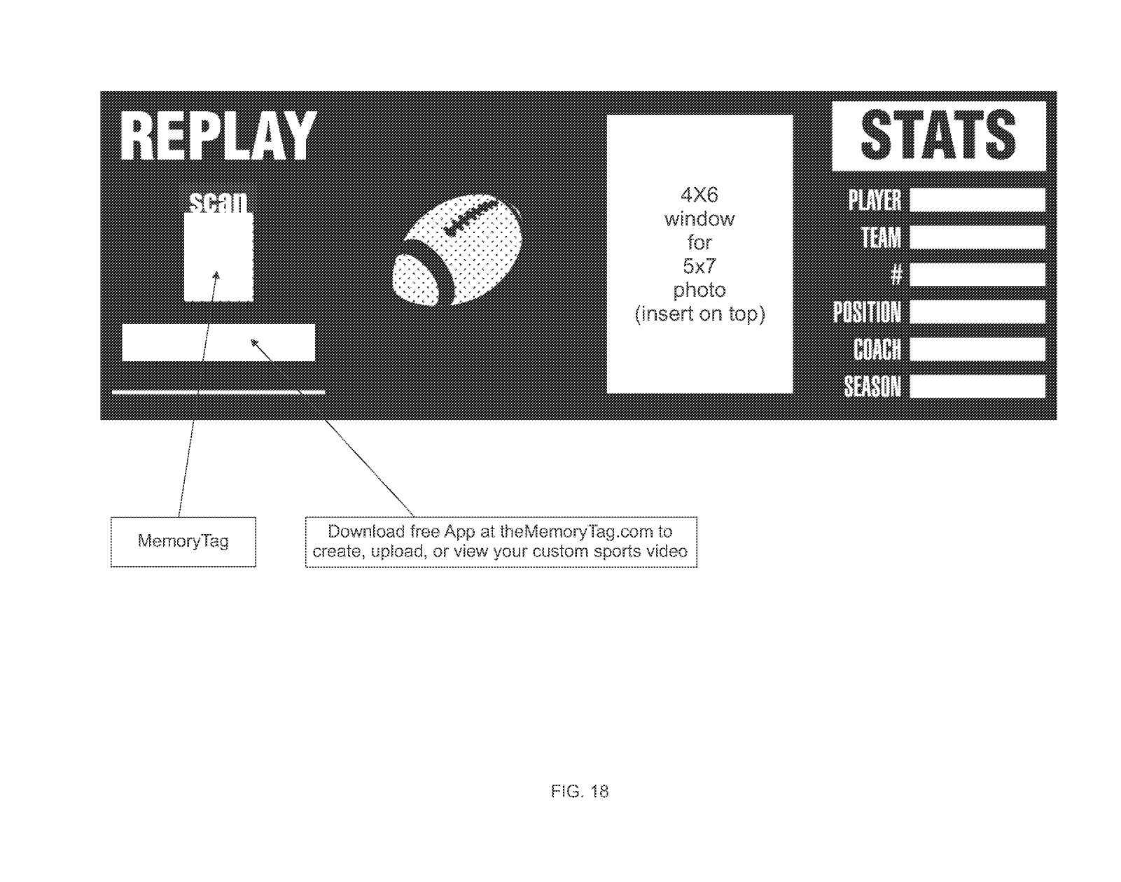

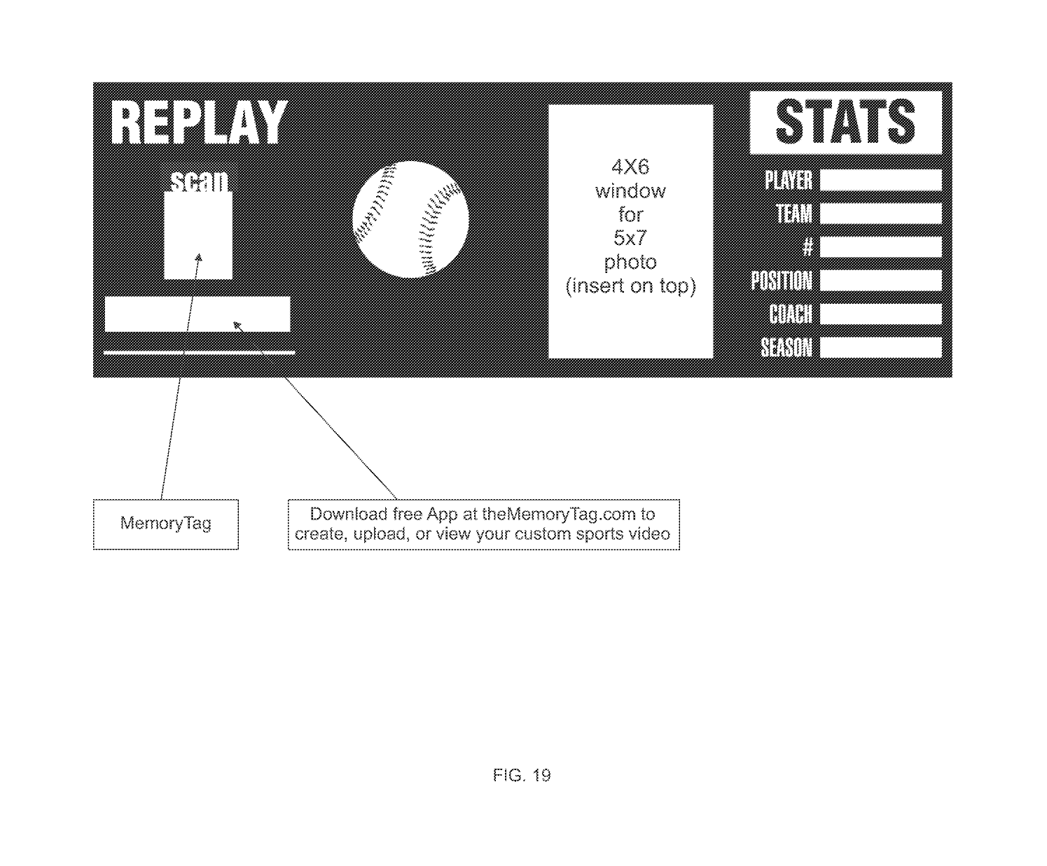

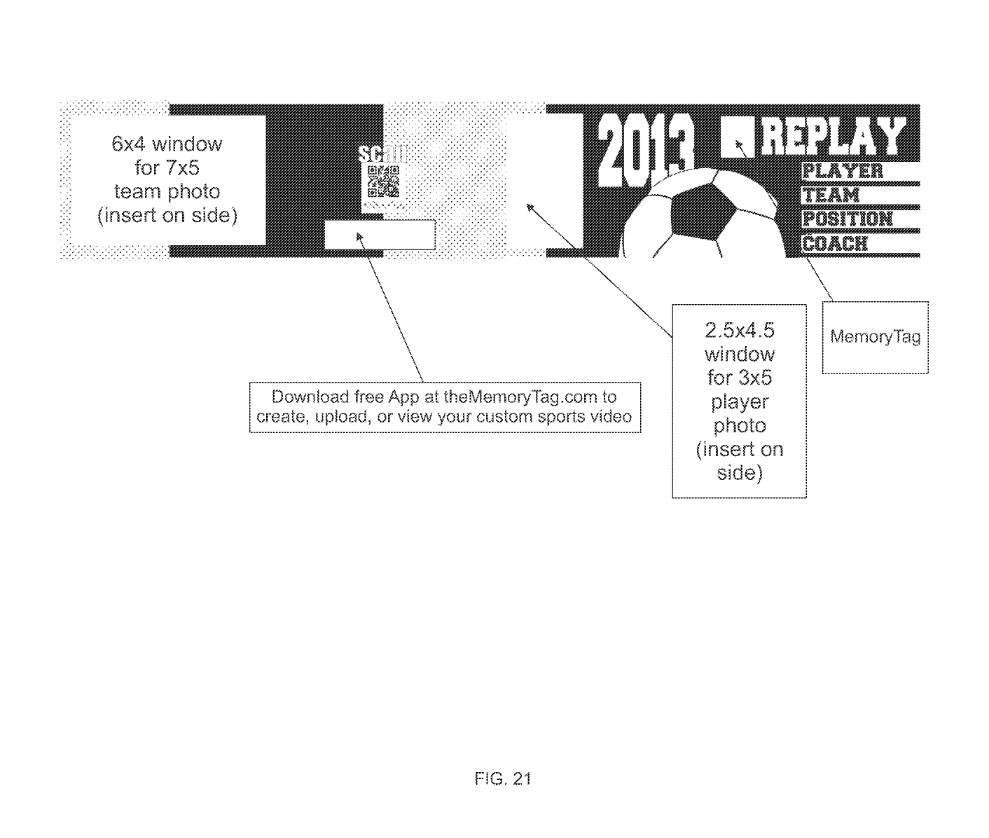

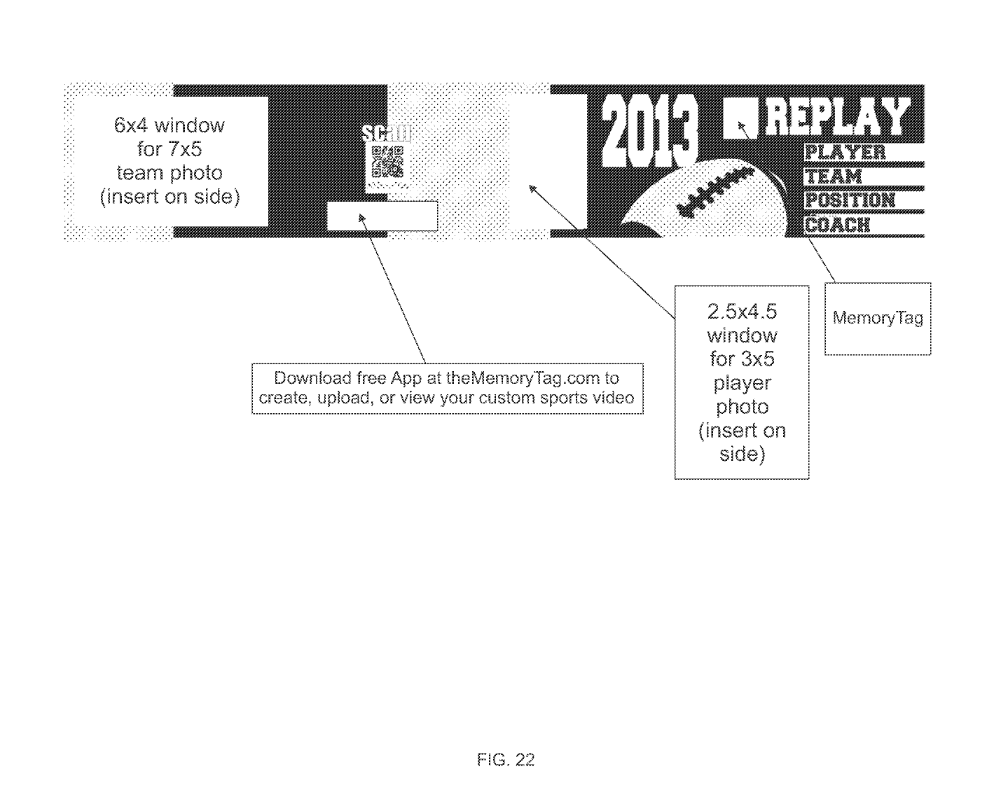

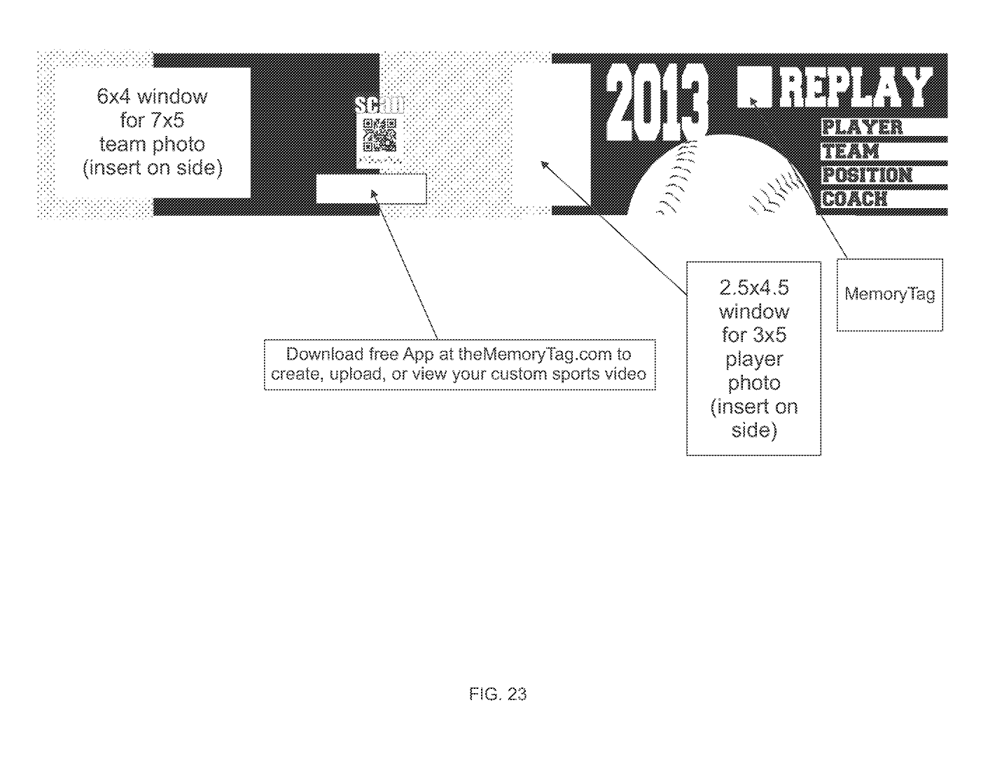

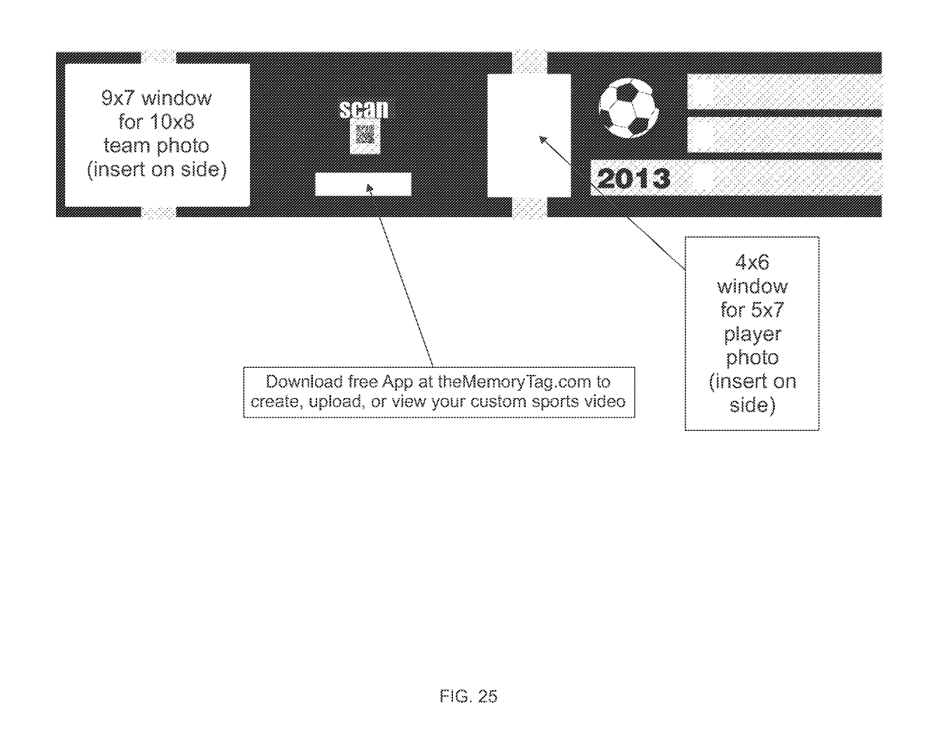

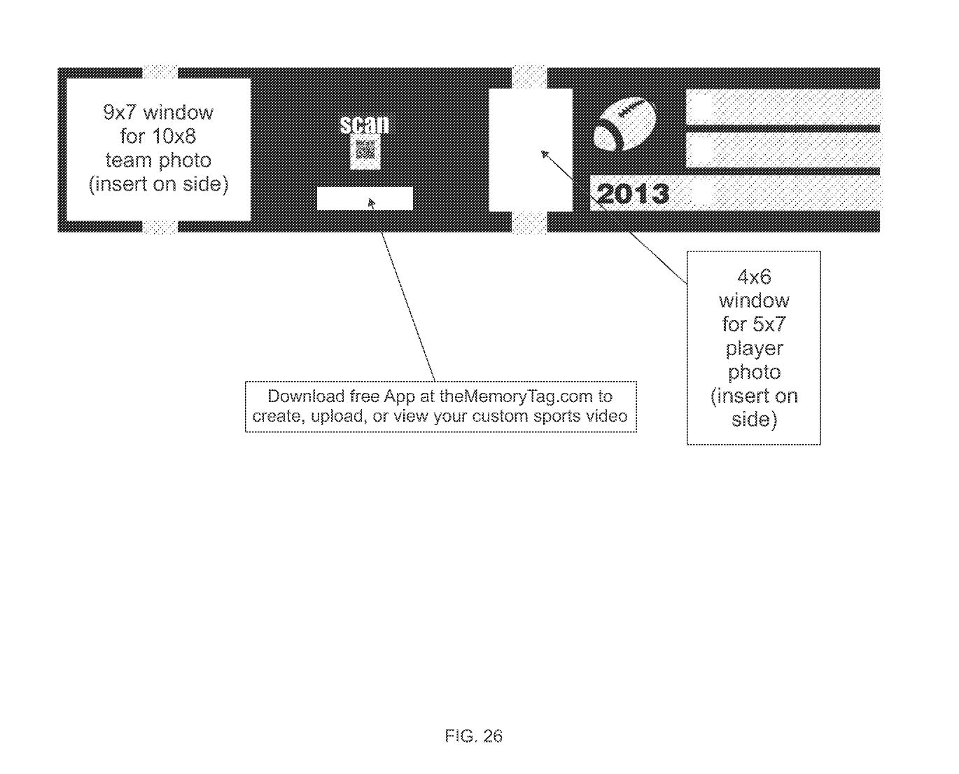

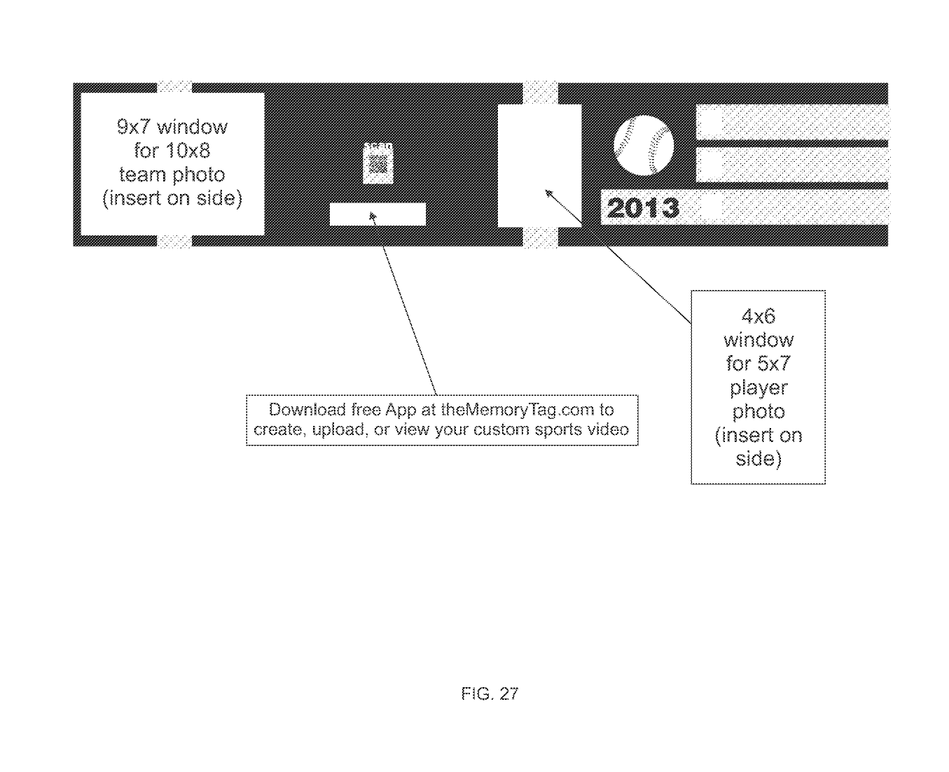

FIGS. 16-27 are illustrative examples of non-limiting embodiments of the present invention that include various game, player, or bed type activities. Drawings are shown in black and white, but all colors can be used with the momento in conjunction with the present invention, with the hybrid multi dimensional bar text code associated with various file types as previously discussed, and can be protected by some means, for example, with a password. Although sizes for typical pictures and portraits are shown in the figures, these sizes are not meant to be limiting examples of the present invention.

FIGS. 16-19 are illustrative examples of momentos that can be used to showcase an event, such as but not limited to a sports game or a wedding, for example using this present invention involving the use of a hybrid multi dimensional bar text code. Some non-limiting examples of sport momentos may include baseball, basketball, football, soccer, bowling, archery, fishing and other sports. Some non-limiting examples of event mementos may include weddings, anniversaries, romantic holidays such as Valentine's Day, any holiday occurring on any day of the year such as bosses day, administrative professionals' day, and nurses day, for example.

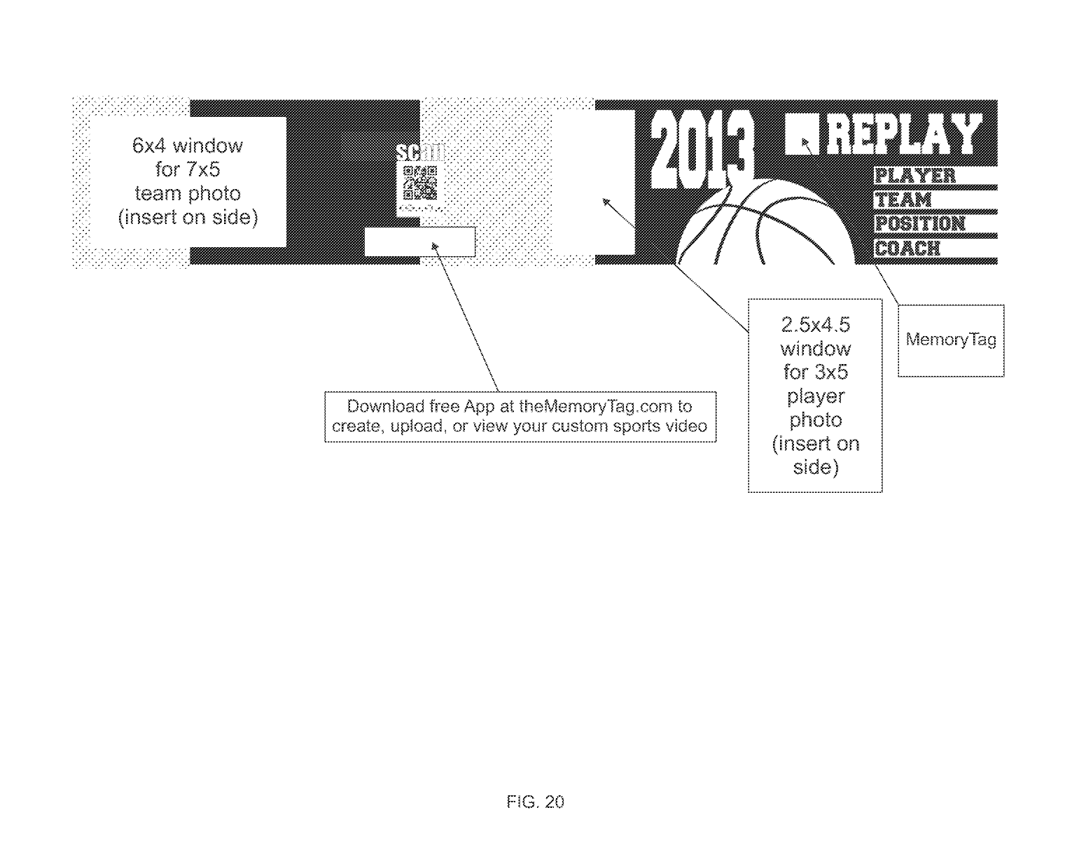

FIGS. 20-23 are illustrative examples of momentos that can be used to showcase an event, such as, but not limited to, a sports game or a wedding, for example using this present invention involving the use of a hybrid multi dimensional bar text code. Some non-limiting examples of sport momentos may include baseball, basketball, football, soccer, bowling, archery, fishing and other sports. Some non-limiting examples of event mementos may include weddings, anniversaries, romantic holidays such as Valentine's Day, any holiday occurring on any day of the year such as bosses day, administrative assistants day, and nurses day, for example.

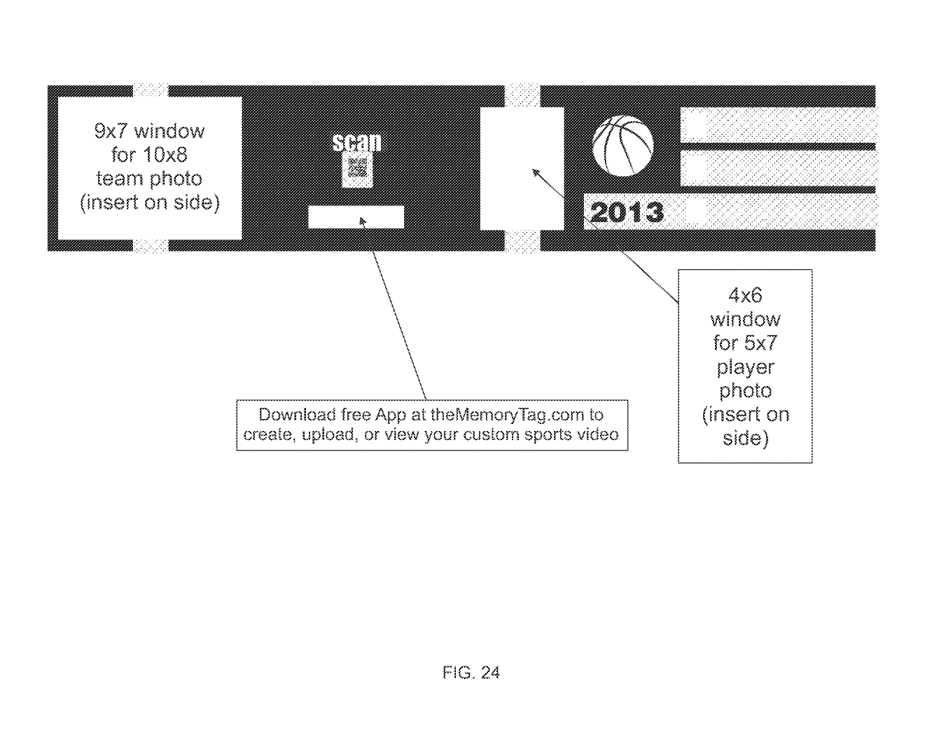

FIGS. 24-27 are illustrative examples of momentos that can be used to showcase an event, such as, but not limited to, a sports season or a wedding, for example where there are spaces for at least one picture and using this present invention involving the use of a hybrid multi dimensional bar text code. Some non-limiting examples of sport momentos may include baseball, basketball, football, soccer, bowling, archery, fishing and other sports. Some non-limiting examples of event mementos may include weddings, anniversaries, romantic holidays such as Valentine's Day, religious holidays such as Christmas or Hanukkah, for example, and other holidays may also include Boss's day, administrative assistants day, and Nurses day/week, for example.

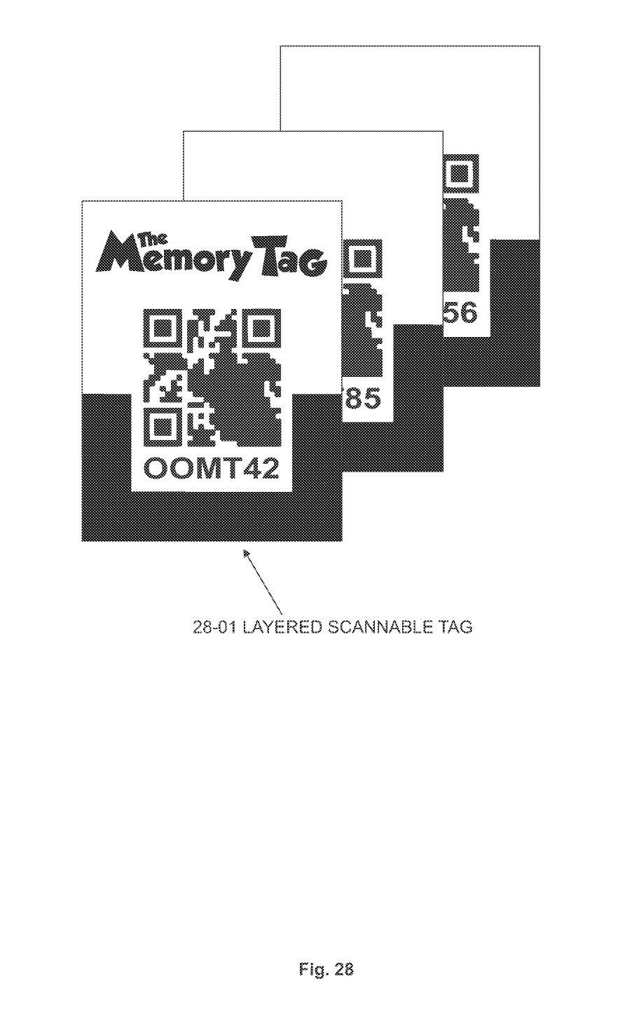

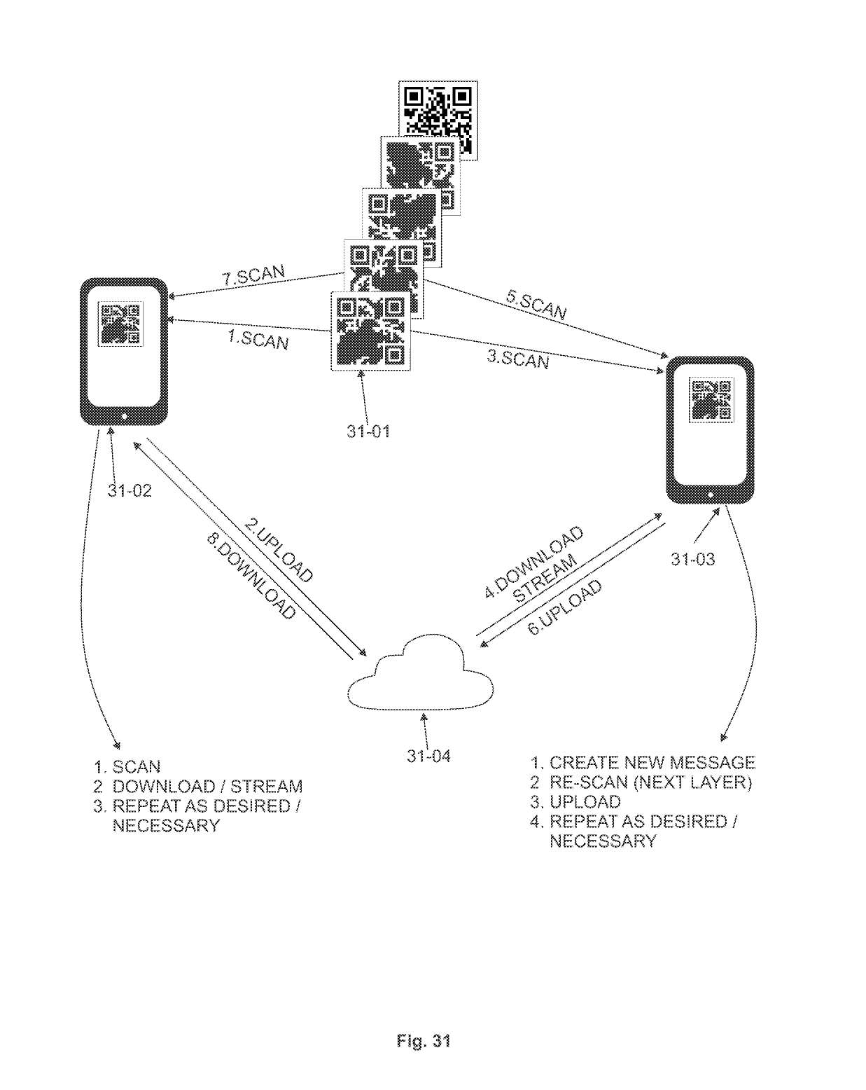

The layered scannable tag 28-01 shown in FIG. 28, is illustrated showing an exploded type view illustrative example that depicts one embodiment of the present invention involving the use of hybrid multi-dimensional bar text code of multiple scannable layers. These separate scannable layers allow for a user to interact with another user through the same physical layered scannable tag 28-01 (explained in more detail in FIG. 31, below).

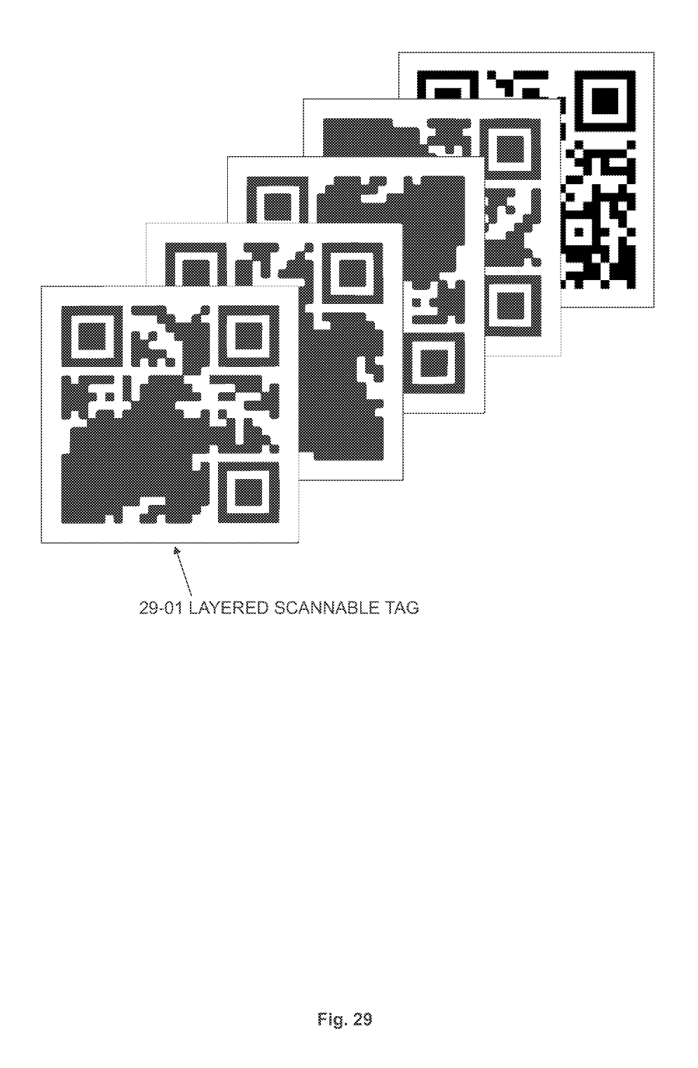

Another non-limiting embodiment of the present invention is shown in FIG. 29. This is an illustrative example that depicts one embodiment of the present invention involving the use of layered QR codes, but other codes or data matricies can be utilized as well, which can come in any shapes and sizes such as shapes of people's faces, any animal or body part thereof, any flowers, or plants, or any living or non-living thing: shapes, faces, flowers, plants, animals, cars, tires, and other everyday objects, aesthetic or not.

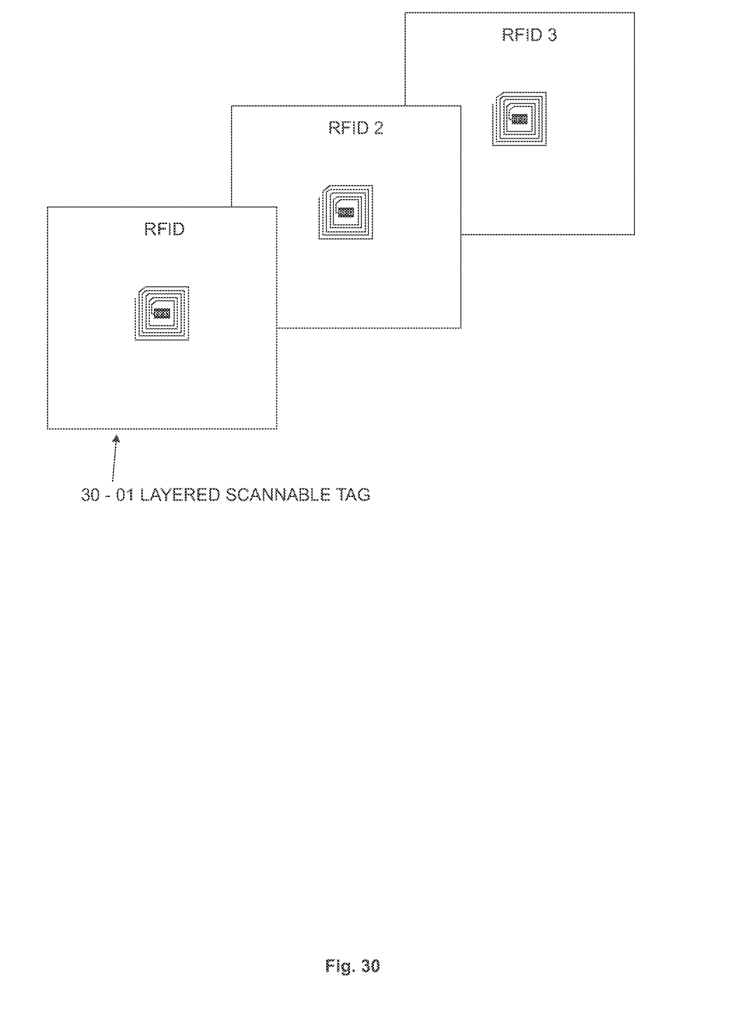

FIG. 30 is an illustrative example that depicts one embodiment of the present invention showing the use of layered RFID tags to allow a user to interact with another user using multiple layered scannable tags, such as specialized RFID tags.

The flow chart in FIG. 31 illustrates one of the many embodiments of the present invention of the multilayer scannable tag 31-01, where a user can scan a tag using a device capable of such activity 31-02, upload a file to the cloud shown in arrow 2, associated with the tag, where a second user may scan the tag with their enabled device 31-03 and watch the video by downloading (arrow 4), and repeat the process when sending a response using another layer within the scannable tag by scanning another layer (arrow 5), and uploading to the cloud 31-04 the video or file to be associated with the second layer of the tag (arrow 6), wherein the first, or another, user may scan the second layer of the multiple layered scannable tag (arrow 7), to get access to the second file uploaded by the second user by downloading (arrow 8) from the cloud 31-04. This process can be repeated infinite times depending on the users' preferences.

In another example of this present embodiment, the administrator of the application and application's server may have powers to manage user submitted data. The administrator of the application may decide to remove uploaded files if it is within their discretion. The administrator of the application of this present invention may also manage payment information.

The scannable tag may also provide a physical-to-virtual (P2V), and continued virtual, and back to physical realm, enabling users to interacting with others, including businesses or other organizations. There are examples of QR codes, that once scanned, may link the user directly to a website, usually consisting of the advertising something (such as a good), but there are not examples where scanning a scannable tag, equipped with data matrix, that allows the user to selectively upload or share their multimedia with others across the current popular social media sites, using an “App” used in conjunction (or as a stand alone) with the App's own specialized social media platform that provides the user with more options, functionality, allowing a more interactive and personal experience between persons, person to business, or business to business types of interaction.

This specialized social media platform, is not limited to sharing on its own site, but may also share on other sites or onto other social media platforms.

Once uploaded, the length of time these files stay on the server may be selected and maintained by the user, wherein the user can adjust or select the duration that the files are maintained or otherwise stay on the server. The shorter, or longer the file stands server, a fee may be required to maintain this request, but it is possible with the system. Most users may select the default option, which may be specified by the administrator of the server (could range from seconds, to minutes, to hours, to days, to weeks, or maybe even a month or more), but in the event that the user wants to choose something other than the default, a fee for this maintenance may be levied against the user's file that was uploaded.

The App provides an interactive page that allows or facilitates the scan of the scannable tag, to allow the user to upload various file types, including but not limited to, video, audio, pictures, or any other type of multimedia file, or any other file that the user wants to upload (providing that it is within the terms of service of the App), and selectively upload that to their own unique channel or unique user page, which may include a personal channel or a business channel, or a group channel, for example—where others may follow or watch the various channels, and even interact or post their own videos back to the original poster, linking to another layer of the scannable tag, for example.

Once uploaded, another user may scan this scannable tag, which may have more than one layer, or family of layers, that allows the user to visit various components associated with each layer within the specialized social media platform, for example for a business, for an employee of the business, or the employee page, or any personal social media platform page, previously set up by the user, wherein the scannable tag is linked from the physical scannable tag, to a virtual world, linking another user to this specialized social media platform so that they can continue to interact.

Besides personal uses, the scannable tag may also be used for business-to-business (B2B) purposes as well. For example, the multilayered scannable tag may provide an interactive experience with a manager, wherein the manager could scan the scannable tag and upload a message to her employees about recent changes in company policy, and once the employees have scanned the tag and watched, or viewed the message of the manager, the employees would be able to upload their response(s) to the message of the manager—to provide a personalized message or response to the group or individuals once scanned.

These multilevel, or multilayered scannable tags, will also allow for many other possibilities including, but not limited to, the opportunity for employees (workers, laborers, etc.) to interact with upper management to provide feedback on, for example, and not limited to, safety protocols where direct documentation can be obtained by scanning a multilevel tag and the user may uploads to the cloud, and becomes immediately accessible to upper-level safety management personnel, for example, so that they can quickly and adequately respond to any safety issue raised, and this would also provide an opportunity for the upper-level management to respond to this issue to let people know that of reported the issue that there report has been seen. The system would provide for adequate chain of custody and documenting employees concerns for any issue.

In another non-preferred embodiment, if a user goes to a store, such a shoe store, the user can scan a scannable tag on the shoe box or shoe of and this scanning event would link the user directly to the company's content, and social platform or respond in various way to give feedback directly, and potentially immediately, back through the tag to the user's profile or company's profile within the social media platform.

Additionally, a person-2-person sharing may also occur, where a user may place a scannable tag on their locker, another (person) with a device capable of scanning the tag, can respond directly to the first user, watch the first user's content or go to the first user's social media platform and view that user's profile, videos, content, based upon privilege information embedded into the layered scannable tag or within the application preferences.

These multilevel, or multilayered, scannable tags would have a data matrix that corresponds to a particular user, and their uploaded data, and the website by way of utilizing at least one layer of the scannable tags through the code system as defined by this specification. For example, the layers may correspond to at least one of the following, scan and watch; go to website; responding back (with read response receipts); responding with video response (video conversation, such as email), replies, where each layer can correspond with retrieving, sending, or interact to form other useful functions with the said layers.

While examples above contemplate the use of tags in certain circumstances and applied to various types of media, it will be understood that the multilevel, or multilayered, scannable tags can also be utilized with media such as letters, postcards, business cards, fliers, brochures, greeting cards, envelopes, invoices, signs, as well as other printed and electronic communication media, such as e-books and digital signage, that would be known to one of ordinary skill in the art with the present disclosure before them. It will be understood that basic concepts regarding the generation of a multilevel, or multilayered, scannable tag are provided in greater detail, supra.

According to some embodiments, multilevel, or multilayered, scannable tags may be utilized for business or commercial-specific applications. More specifically, but not by way of limitation, a tag may be used by a business to effectively create, track, and publish videos (or other media files) for marketing or customer communication purposes.

In these instances The App provides a tag owner with full viewing and manipulation control over various tag attributes. Example tag attributes include, but are not limited to, a number of scans for the tag, duration of use for the file associated with the tag, a geo-location that is indicative of a location where the tag was scanned, and monetization features.

With respect to a number of scans, The App may generate a user interface that provides the owner with metrics or statistics regarding the number of times that a tag has been scanned. For example, The App may be configured to provide the owner with metrics that designate how many times the tag has been scanned in a week, a month, or any other time period. In other instances the number of scans may be determined without reference to a specific time period and would refer to an aggregate or total scan number.

On a related matter, the owner may also be allowed to specify how many times a tag can be scanned. For example, a tag is attributed a specific number of scans such as 100. The number of scans may be associated with an action or set of actions that occur when the number of scans reaches this preset threshold. For example, a tag may be associated initially with a first advertisement video that is stored in the cloud. After 100 scans the tag may be automatically re-associated with a second advertisement video that is also stored in the cloud. In this way the owner can ensure that the content associate with the tag remains fresh and relevant to a target audience.

With regard to the metric of duration of use of the file associated with the tag, The App may allow the owner of a tag to determine, for example, how long a video file was watched. This information will indicate to the owner if those viewing the video file are engaged or interested in the content. It can be assumed that if the overall video file duration is five minutes, but viewers are only watching the first two minutes of the video file that viewers are becoming disinterested in the content of the video file.

Another metric that may be tracked is a determination of what time viewers stopped a video file. For example, it may be determined that viewers stop watching a video file at one minute when the overall duration of the video is three minutes. It could be inferred that the content occurring around minute one and a half is somehow causing viewers to lose interest. Knowing video file metrics such as viewing duration and stopping time may allow the owner to query viewers about the content of the video file in light of their actual viewing behaviors.

Another analytic/metric that is tracked includes the geo-location where a tag was scanned. For example, the geo-location information may include global positioning system (GPS) data such as latitude and longitude where a computing device scanned a tag. This geo-location information can be captured by requiring the computing device that scanned the tag to attach current GPS location information for the computing device (if available). Alternatively, the computing device can attach a last known position information for the computing device if a current GPS signal is unavailable. Notwithstanding, in some instances the geo-location information is attached to a message that is transmitted when the computing device requests the content (such as a video file) that is coupled with the scanned tag. In another embodiment, the link for the video file is not displayed to the viewer until the viewer gives permission for the computing device to provide its GPS information to a server that tracks the analytics and metrics for tags. Again, an example server includes the memory tag system website server of FIG. 7. In another embodiment, the server may record geo-location information for the computing device at the time at which the computing device requested the video, audio, or other file.

In another embodiment a metric of viewer device platform is determined when a tag is scanned or a file associated with the tag is accessed. For example, the viewer may use a device (such as the camera enabled smart phone of FIG. 10) that executes a specific brand of operating system such as Android (trademarked), iOS (trademarked), Windows (trademarked), or other operating system. The operating system type can be determined from descriptive information that is provided by the computing device of the viewer, either in response to a request or from gathering information from, for example, a web browser client application that executes on the computing device. The operating system used by the computing device can often be inferred from web browser client application type or communication protocol type used by the communication device.

As mentioned above, an example tag of the present technology may be embodied as a 2D barcode that is affixed to a product. A viewer may use a device to take a picture of the 2D bar code, for example, with a camera enabled cell phone that will redirect them to the programmed URL. The phrase “taking a picture” or “take a picture” will be understood to include, for example, scanning the 2D bar code using known bar code scanning methodologies. In one example, cell phones can execute bar code reading applications that identify, capture, or otherwise receiving the 2D bar code using the camera of the cell phone. Thus, the bar code scanning application may process the view captured by the camera and extract or determine information included in the scanned 2D bar code. So it will be understood that aspect of taking a picture is not strictly confined to a traditional image capturing and storing procedure, but may also include instances where visual information, such as a bar code or QR code is obtained using a camera. This information can be stored locally on the device or may be utilized within the runtime memory of the scanning application that is utilized.

The present technology also contemplates other known methods for identification and translation of encoded images that would be known to one of ordinary skill in the art with the present disclosure before them.

In other embodiments, metrics that relate to other attributes of the computing device of the viewer that impact video/audio playback are requested from the computing device. These attributes may include display size, display resolution, video processor type and speed, web browser application type, display driver settings, video/audio file format compatibility (e.g., which types of media files can be played by this device), as well as other attributes of the viewer's device.

Another metric includes a location of a link that was clicked by a viewer in order to access a file that is associated with a tag. For example, the link may be displayed on a social network, a website, a blog, or any of the online media types described herein. If the point of origin of a request can be determined, such metrics are tracked.

The metrics described in the foregoing paragraphs can be tracked for an owner. These metrics can be tracked over time and can provide the owner with insight into how viewers are finding, requesting, and ultimately using the owner's files. Owners can specify which of the metrics they are interested in tracking, using The App. A cost is associated with the tracking of one or more metrics. That is, the owner is required to pay for The App to track metrics. When the tag and file are used in the context of a marketing campaign, these metrics can be used as key performance indicators (KPI) that inform the owners of the success of a particular marketing campaign.

Owners can request the creation and display (e.g., either over the network or available for download) of reports regarding their selected metrics. These reports are also provided at a cost to the owner.

In some embodiments, The App is configured to log the number of times a video is watched, the type of device requesting the video, and where that device is located (in addition to date and time). These metrics are uploaded to a server database and synchronized with similar analytic data that has been tracked and retrieved from the playback pages from a website, which tracks browser views.

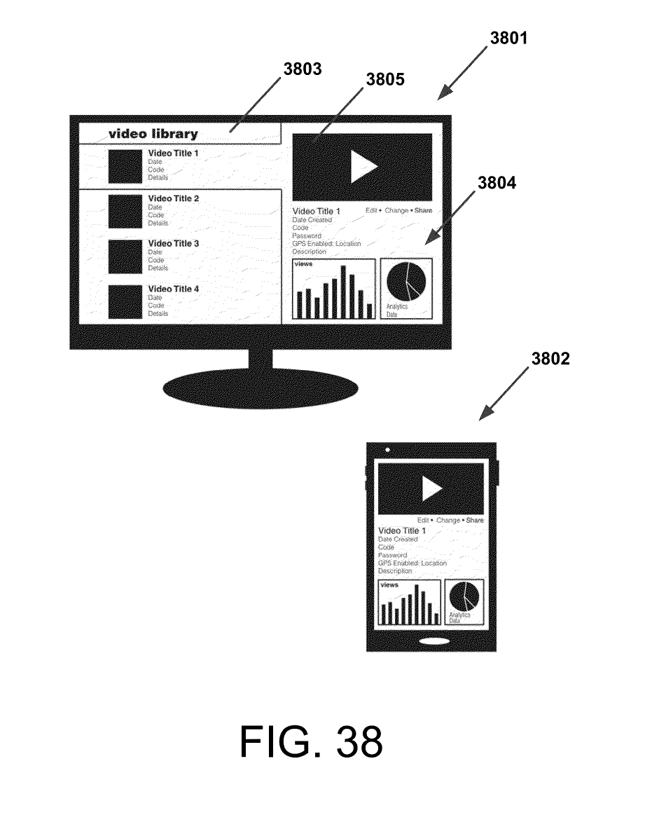

Anytime an owner wishes to access and review their video information, data from both The App and browser views is made available to them. The information may be viewed by the owner either logging into The App or logging into their dashboard (see FIG. 38 for an exemplary dashboard). The logs are downloaded from the database and displayed on the screen or page. Additional details regarding the dashboard are provided below.

A dashboard user interface, such as the dashboards illustrated in FIG. 38, is created for the owner and can be used not only for configuration of tags, but also for report creation and viewing. This dashboard can also present the owner with various types of data regarding their files. For example, the dashboard may display to an owner a title and password for a file. Other fields for a file are also displayable such as client name, which may include the names of customers that are the intended targets for the file. Another field includes a marketing campaign identifier that allows the owner to specify a marketing campaign to which a tag belongs. For example, the owner may have two marketing campaigns or categories such as “Frugal Customers” and “Affluent Customers”. Tags may be created for each of these marketing campaigns and these tags can be segregated into their appropriate category. For example, tags that are coupled to video files that target affluent customers are identified and placed into the “Affluent Customers” category.

Other types of tag information such as number of tags in circulation, and any other measurable (and ultimately measured) attribute of a tag can be displayed to the owner.

With respect to owner accounts, and specifically when an owner account is associated with an organization, rather than an individual, The App allows for role-based account access. For example, a company may have multiple team members that involved with marketing, such as a marketing director and one or more marketing subordinates. Each of these individuals can be assigned a different degree of access to a company's tags. For example, the marketing director can have complete control and full access to all tags for the company. A marketing subordinate may have the right to view and edit tags and/or files, but not the right to publish a tag or file. A company account may require a subscription fee that is based upon the size of the company or number of company employees who require access to The App, as well as the functionalities required by the company.

The App also provides accounts that provide features at differing price points. For example, a small business account may follow a pay-as-you-go model (pay for each service individually as-needed). Alternatively, a mid-sized account may pay a monthly subscription to gain a greater number of unlocked functions and a certain number of “credits” which may be used to change videos more frequently (among other things).

A large-business account may pay a higher monthly subscription to unlock all features, such as reporting, and maintain unlimited changes to all tags and associated videos. For the small and medium accounts, any user who has zero credit but wants to change a video may tap the “change” button. The App will recognize that they have no credit and will inform them that there is a price to do so. If the user agrees to the price, they are navigated to a native application store window for payment. This native application store is facilitated, for example, in the mobile device area, by the manufacturer of the operating system for the device. By way of example, devices that use the iOS operating system will use the Apple iTunes Store (trademarked). Upon completion of the payment, a credit is added to the user's account and the owner is given the option to use the credit for the purpose of changing the video. The owner may repeat this process as often as desired. With respect to monetization, The App allows an owner to monetize advertisements that are displayed along with their file that is linked to a tag. For example, a tag may be linked to a video file. In turn, the video file is associated or linked with advertising content that can be displayed or presented to a viewer before, during, or after the presentation of the video file. By way of example, a video file may be coupled with a banner advertisement that is presented to the viewer along with the video file. Other combinations of files and advertisements and their respective methods of presentation that would be known to one of ordinary skill in the art are also likewise contemplated for use in accordance with the present technology.

In accordance with the present disclosure a tag is configured so as to allow the owner to change a message and/or associated file as desired. Rather than requiring the owner to create a new tag when the content associated with the tag changes, the owner can selectively couple the tag with a new message or content as desired. For example, the owner may initially couple a first video file with a tag. As mentioned above, the first video file is stored in the cloud at a particular location or address, referred to as a first path. Rather than creating a new tag the owner can simply associate a subsequent file with the tag by updating the location or address, referred to as a second path. The coupling of the tag with new content may require the owner to upload the new content to the cloud. In some instances the tag can be rotatingly or periodically associated with a plurality of files. For example, the tag owner may upload five different video files to cloud storage, where each of these five video files has a unique location. The tag is couplable with each of these five video files at different times or at different time intervals.

The owner may specify a schedule that determines when the video files are coupled with the tag. For example, the first video file is coupled with the tag for one week. The following week the second video file is coupled with the tag, and so forth, ending with the fifth video file. In another example the tag is associated with a different video file each time the tag is scanned. For example, upon a first scan the first video is displayed to a viewer. Upon a second scan the second video is displayed to a viewer. While these example schedules have been provided for descriptive purposes it will be apparent to one of ordinary skill in the art that other similar schedules can also likewise be utilized.

In some instances, a plurality of different video files (or other types of files) may be associated with different layers of the multi-layer tag. For example, a multi-layer tag may include three separate, unique layers. A unique file can be associated with each of the layers and a unique link is created for each layer. For example, a first layer of the tag may include a link to a first video file. A second layer of the tag may include a link to a second video file, while a third layer of the tag may include a link to a third video file, where all the video files are stored on the cloud resource. Stated otherwise, a multi-layer scannable tag may comprise a plurality of unique URL links and a plurality of unique layers, each of the plurality of unique layers embedding one of the plurality of unique URL links

In one example the first video file is a high definition version of a video. The second video file is a lower definition of the same video. Based upon knowledge about the viewer computing device or the network used by the viewer computing device, The App may intelligently select an appropriate version of the video file for the viewer computing device. In general, The App may select one of the plurality of unique layers to read based upon device characteristics of the computing device that scanned the multi-layer scannable tag.

The App that executes on the viewer computing device can be configured to distinguish between the various layers of the tag. In some instances, when the tag is scanned, The App may select which of the layers is read. In the example above, The App may determine that the viewer computing device is not capable of displaying high definition video. Thus, The App reads the second layer of the tag, rather than the first layer. The viewer computing device obtains the second file from the second URL.

In some embodiments, if the file associated with a tag is a video file, the playback duration of the video file may be limited to thirty seconds. This playback duration can be increased to any desired duration. The App may apply a cost multiplier that corresponds to the increase in playback duration. In instances where the owner has purchased a subscription, the subscription fee can be increased. When the owner is on a pay-per-play cost structure, the owner is billed more per each playback of the content having an extended duration.

In accordance with the present disclosure a file or files associated with a tag can be modified using The App. In one embodiment the tag is scanned by the owner. Assuming that the owner has been authenticated by The App, the scanned tag is opened for modification. The owner can change the file associated with the tag or make other modifications to the tag. This may require the owner to upload a file to the cloud if the file is not already present on the cloud. When finished, the tag is updated on the cloud and published for use in any of the mediums described above. Each time an owner changes the file that is coupled with the tag, a cost may be assessed to the owner.

As mentioned above, the tag can be applied to many different types of mediums, some of which cannot be readily updated, such as physical mediums (e.g., newspapers, magazines, signage, etc.). It is preferred in these instances that the link or location associated with the tag not change. Again, the tag is originally assigned a first path or location in relation to a file on the cloud. Thus, the original file stored in the cloud can be deleted and replaced with an updated file. The tag need not be updated and still point to the first path on the cloud. Alternatively, if the first path changes the tag is updated to reflect this change. Embodiments where the tag is displayed in a virtual format can more easily accommodate changes in the tag.

In some embodiments, a server, such as the memorytag system website server of FIG. 7, track tag usage and determines monetary charges for tag use. For example, each time a tag is scanned the owner of the tag is charged a set amount. In other example, the charge is attributed not only to the scanning of the tag, but additionally to the viewing of the file associated with the tag. When a viewer actually views the file associated with a scanned tag the owner is charged. An amount that is charged to the owner when a file is viewed can be set at an amount that is greater than a charge if the tag is scanned but the file is not viewed. This cost structure is due, at least in part, to the cost associated with the delivery of the content to the viewer.

A tag owner is assigned a custom URL that can be used by the owner to direct customers, clients, associates, friends, and other third parties to the files that are hosted on the cloud. The customized webpage or dashboard is displayed when the third party accesses the custom URL. The tag owner may control the selection, placement, and display of the files on the custom URL. The App can be configured to provide control functionalities to the owner. In some instances the webpage associated with the custom URL can be branded with the owner's logo, trade name, graphics, artwork, or other creative media.

According to some embodiments, rather than linking or coupling a file to a tag, the tag is associated with, for example, a discount universal product code (UPC). In this embodiment, the owner would upload a barcode image to the cloud, which is logically associated with the tag. When uploaded, the barcode image is stored in the cloud and assigned a location identifier such as a uniform resource identifier (URI), a URL, or any other location identifier that can be used to identify the location of an object or file stored in a cloud storage system. The owner specifies a discount or special deal that is provided when the UPC is scanned at a retail establishment. For example, the UPC may provide a twenty percent discount on a garment. The instructions or information that specifies the parameters of the deal or discount are stored in a record in the cloud. Requests for the UPC will cause the cloud to respond with the parameters of the deal or discount.

While a barcode image has been disclosed, other methods of encoded data can also be used, such as a randomly generated token that includes a set of randomly generate characters that can be associated with the tag. The token can be associated with any type of information such as a discount code, a store credit, a message, or other data. When the owner specifies, for example, a discount code, The App is configured to create a randomly generated token. The token is stored in a database, along with the tag in a record. The token is provided when the tag associated with the token is scanned. The token can be redeemed using The App. For example, a viewer computing device may scan a tag. The token associated with the tag is provided to the viewer computing device. The viewer can redeem the discount code using The App. That is, The App can query the database for the record that includes the token. When the record is located, the discount code is displayed on the viewer computing device.

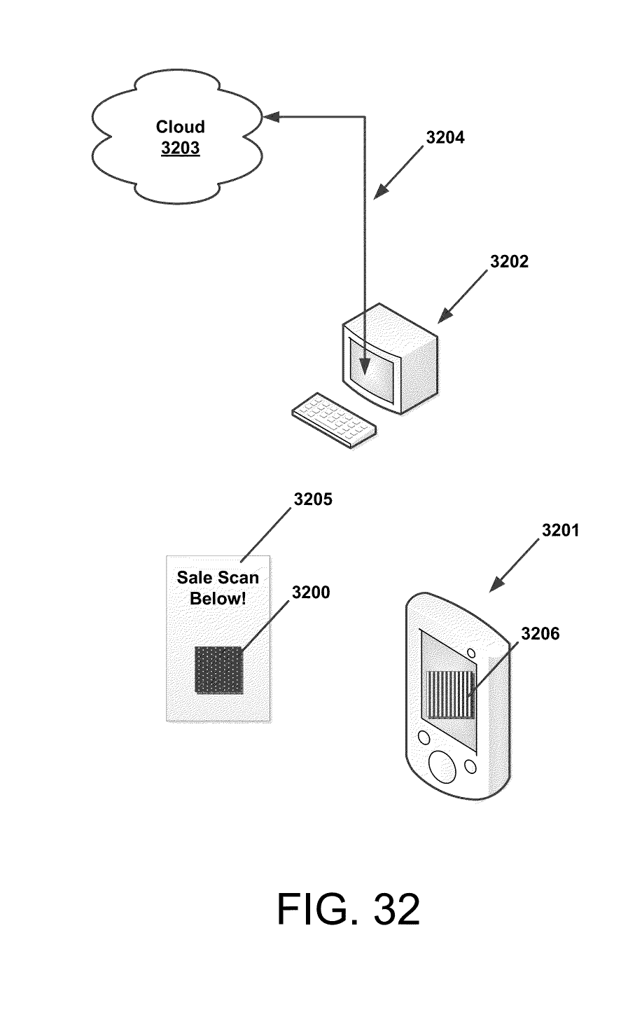

Turning to FIG. 32, when a viewer scans a tag 3200 using a viewer computing device 3201, a barcode image is displayed. In this example the tag 3200 is presented on a sign 3205 located in a retail establishment. When the tag is scanned a barcode image 3206 is displayed on the device 3201. The barcode image 3206 is then scanned by a retail point of sale terminal (POS) 3202 at a retail establishment. The POS terminal 3202 requests instructions from a cloud 3203. These instructions are associated with the discount UPC that is stored in the tag owner's user account or record. That is, when the POS terminal 3202 scans the discount UPC, the cloud 3204 will provide the POS terminal 3202 with instructions that inform the POS terminal 3202 to apply the discount. It will be understood that the POS terminal 3202 and cloud 3203 may communicate with one another over a network connection 3204, which may include any private or public network, such as the Internet.

In another embodiment, the viewer can scan the tag with their computing device. The discount UPC can be downloaded directly to the computing device and stored locally. The App is configured to provide a user interface that includes representations of all discount UPCs that have been downloaded to the computing device. That is, The App is configured to track and display the viewer's downloaded UPCs in a visual format. Alternatively, the viewer can access a mobile or desktop web page that includes the same information as the user interface. This embodiment is preferred when the viewer is not using The App, but is instead accessing discount UPCs through a webpage. The webpage is configured to operate in a manner that is consistent with the operation of The App.

The present technology can also be implemented in a virtual or physical gift card embodiment. Similarly to a discount UPC, the tag can be associated with a gift card, such as a prepaid amount of currency or merchant credit. The merchant may create a record in the cloud that specifies an amount of merchant credit available, for example, $100 of in store credit. This record is coupled to a tag of the present technology using any logical link such as a URL, a uniform resource identifier (URI), a domain, a subdomain, a virtual subdirectory, an IP address, and so forth. The data (e.g., store credit amount) associated with the record can be embodied, for example, in a barcode, a QR code, or any other visual object that is configured to encode data. During a transaction, when the visual object is scanned by the POS terminal, the POS terminal reads the URL encoded in the URL. The POS terminal requests the gift card/certificate information from the cloud using the URL. The cloud returns the requested data and applies the store credit to the balance of the transaction.

In embodiments where a merchant (e.g., owner) of a tag wishes to provide any of the aforementioned objects such as gift card, a discount UPC, or other similar object, the owner can create and manage these tags and associated objects using The App or accessing their owner dashboard over a network. Thus, owners can modify the details of a discount or gift card, if necessary. For example, an owner can specify that a discount UPC is to expire if not used in a specific period of time. In another example, the monetary value of a gift card can progressively decrease over time if the gift card is not used.

In some embodiments, The App may allow viewers or end users of The App to trade or exchange their discounts or gift cards with one another. For example, if a first user receives a discount UPC for a restaurant that they rarely frequent, the first user can exchange that discount UPC with a second user that currently possesses a gift card or discount UPC for a product or service that is frequently used or consumed by the first user. The App may facilitate an exchange or marketplace where users can post unwanted discount UPCs or gift cards. These discount UPCs or gift cards can also be purchased by other users rather than transferred via swap or exchange.

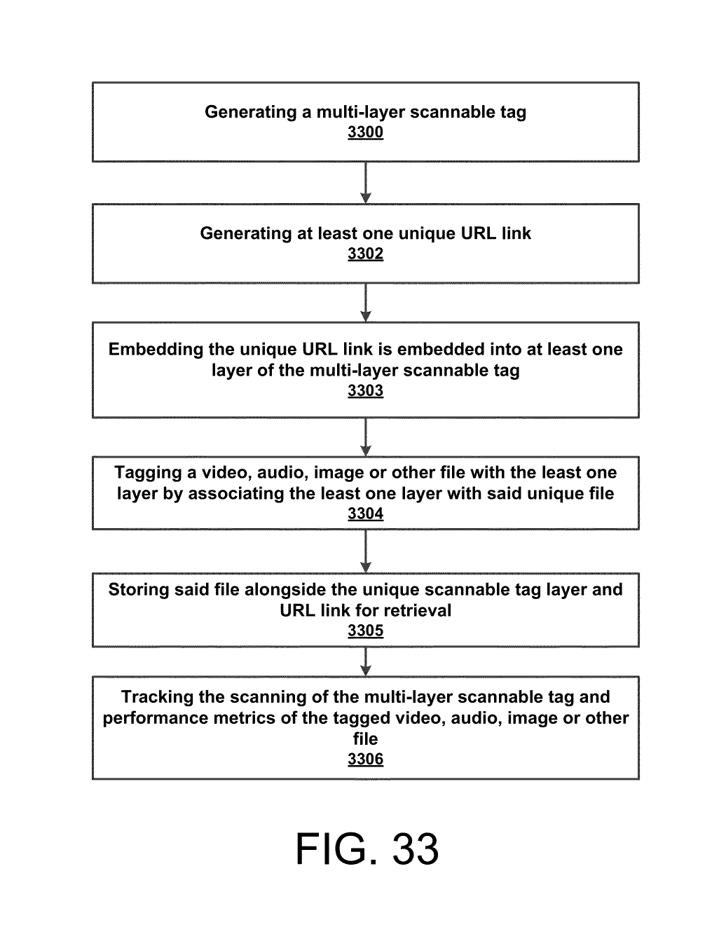

FIG. 33 is a flowchart of an example method that is executed in accordance with the present disclosure. The method includes generating 3301 a multi-layer scannable tag. As mentioned above, generating a multi-layer scannable tag will in some instances include generating a scannable tag that includes a text component. This may include generating the structure of the tag, which includes various layers that are capable of storing data such as links, URLs, or other data.

Next, the method includes generating 3302 at least one unique URL link and embedding 3203 the unique URL link is embedded into at least one layer of the multi-layer scannable tag. For example, the URL may include a virtual sub-directory such as http://www.domain.com/myfolder, or alternatively a subdomain such as mydomain.domain.com.

After embedding the at least one unique URL, the method includes tagging 3304 a video, image, audio or other file video, image, audio or other file with the least one layer by associating the least one layer with said unique file. For example, the subdomain of mydomain.domain.com may be logically associated with a layer of the tag in such a way that scanning of the tag by a device that is configured to scan the tag (such as a device that has The App) will retrieve the unique URL.

Next, the method includes storing 3305 said file alongside the unique scannable tag layer and URL link for retrieval. For example, a video file is stored on a cloud repository. This video file is stored on the path or link that is specified in the tag (e.g., the unique URL).

The method further comprises tracking 3306 the scanning of the multi-layer scannable tag and performance metrics of the tagged video, image, audio or other file. These metrics are storable in a database and can be retrieved for display by the owner of the tag. The various metrics, tracking methods, and display methods for these metrics are described in greater detail supra.

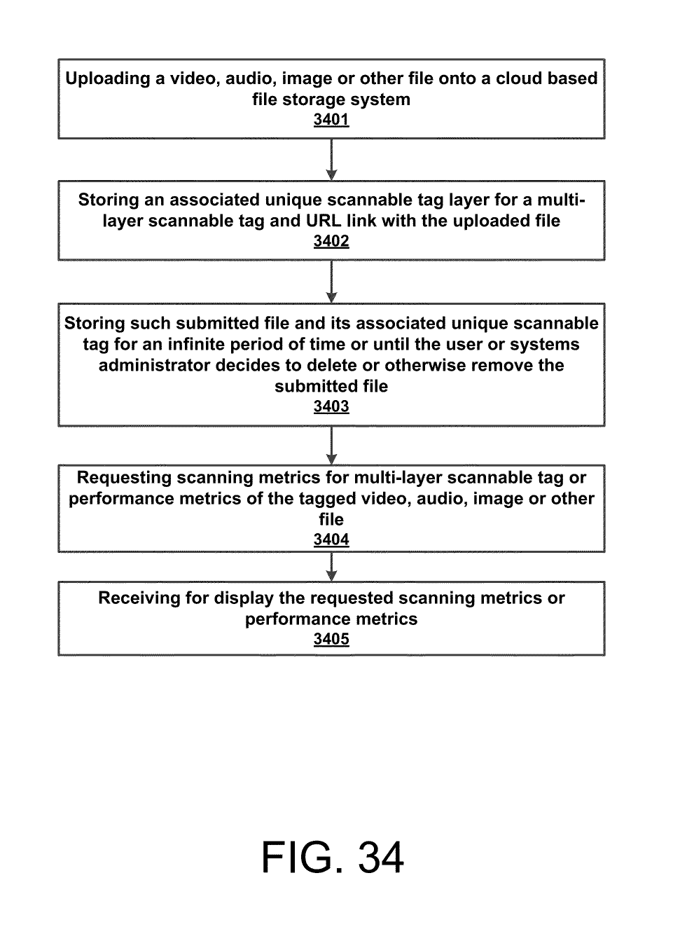

FIG. 34 is a flowchart of an example method that is executed in accordance with the present disclosure. More specifically, FIG. 34 is a method for uploading files and associating one or more files with a scannable tag of the present technology.

The method includes uploading 3401 a video, image, audio or other file video, image, audio or other file onto a cloud based file storage system. For example, a content owner may upload an advertisement video to a cloud based file storage system. Once the file (or files) is uploaded the method includes storing 3402 an associated unique scannable tag layer for a multi-layer scannable tag and URL link with the uploaded file. That is, the file is stored in a location on the cloud based file storage system. A pointer or path to the file is represented as a URL link, which is associated with the unique scannable tag layer of a tag.

Next, the method includes storing 3403 such submitted file and its associated unique scannable tag for an infinite period of time or until the user or systems administrator decides to delete or otherwise remove the submitted file.

According to some embodiments, the method includes requesting 3404 scanning metrics for multi-layer scannable tag or performance metrics of the tagged video, image, audio or other file, as well as subsequently receiving 3405 for display the requested scanning metrics or performance metrics. As mentioned above, these metrics can be requested and displayed on a dashboard user interface. These reports can be provided to the owner for a fee. The fee may include a one-time fee for a report or may include a subscription fee where the owner can receive unlimited reports or reports at given time intervals, such as daily, weekly, monthly, or quarterly.

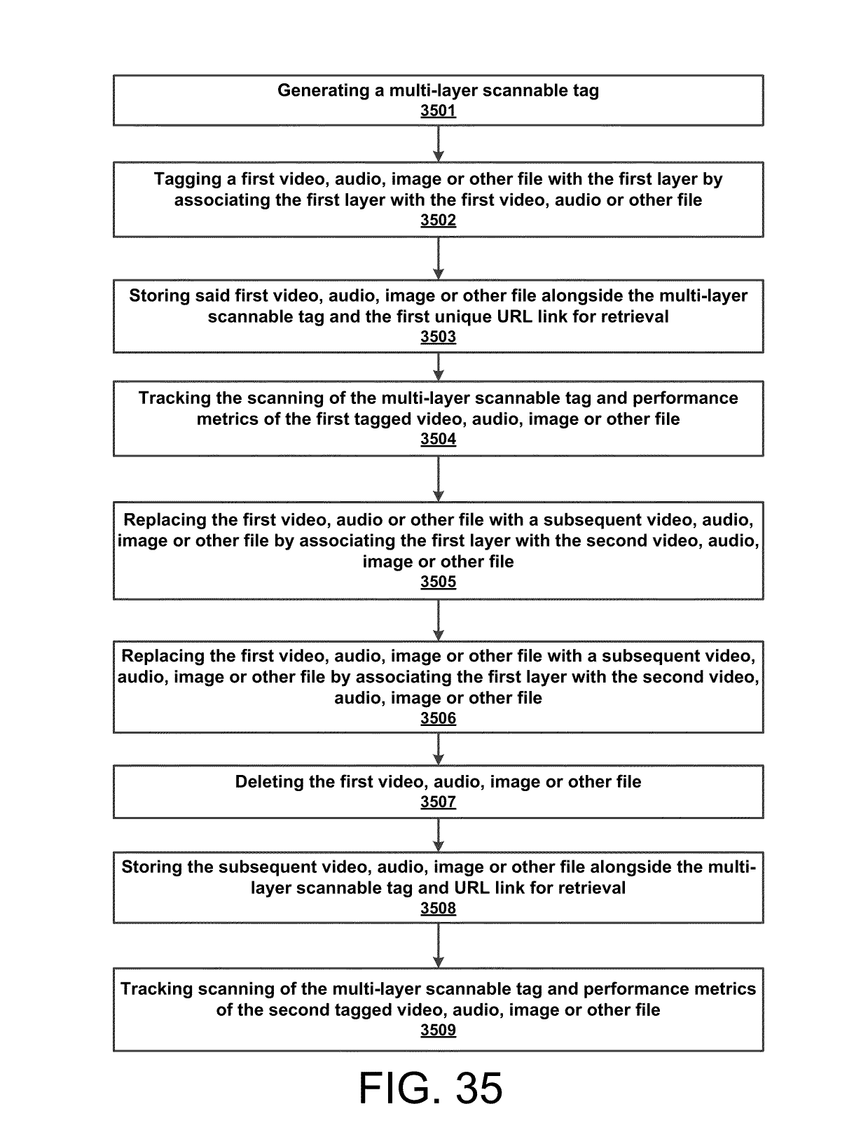

FIG. 35 is a flowchart of a method for creating and updating a multi-layer scannable tag. The method includes generating 3501 a multi-layer scannable tag. The multi-layer scannable tag comprising a first unique URL link wherein the first unique URL link is embedded into a first layer of the multi-layer scannable tag. The method further includes tagging 3502 a first video, image, audio or other file video, image, audio or other file with the first layer by associating the first layer with the first video, image, audio or other file. Subsequently, the method includes storing 3503 said first video, image, audio or other file video, image, audio or other file alongside the multi-layer scannable tag and the first unique URL link for retrieval, as well as tracking 3504 the scanning of the multi-layer scannable tag and performance metrics of the first tagged video, image, audio or other file. For example, an aggregate number of scans of the tag are recorded as a metric.

Next, the method includes replacing 3505 the first video, image, audio or other file video, image, audio or other file with a subsequent video, image, audio or other file video, image, audio or other file by associating the first layer with the second video, image, audio or other file. In order to ensure that this subsequent file is provided when the tag is scanned, the method includes replacing 3506 the first video, image, audio or other file video, image, audio or other file with a subsequent video, image, audio or other file video, image, audio or other file by associating the first layer with the second video, image, audio or other file, and deleting 3507 the first video, image, audio or other file.

The method also includes storing 3508 the subsequent video, image, audio or other file video, image, audio or other file alongside the multi-layer scannable tag and URL link for retrieval, and tracking 3509 scanning of the multi-layer scannable tag and performance metrics of the second tagged video, image, audio or other file. Conceptually, the subsequent file becomes the “first file” and the process can be repeated when the owner decides to change the file associated with the URL link. That is, the URL link remains the same, but the owner can change the file associated with that URL link such that the scannable tag need not be changed to effectuate a change in the file that is associated with the scannable tag. Furthermore, as mentioned above, each time the file is changed a fee may be assessed to the owner.

Rather than replacing the first file, it will be understood that the file can be modified. For example, the owner may change video title, modify a video security/password, or privacy/public options for views, GPS location information, or sharing privileges, and so forth. The edited file would be the “subsequent” file.

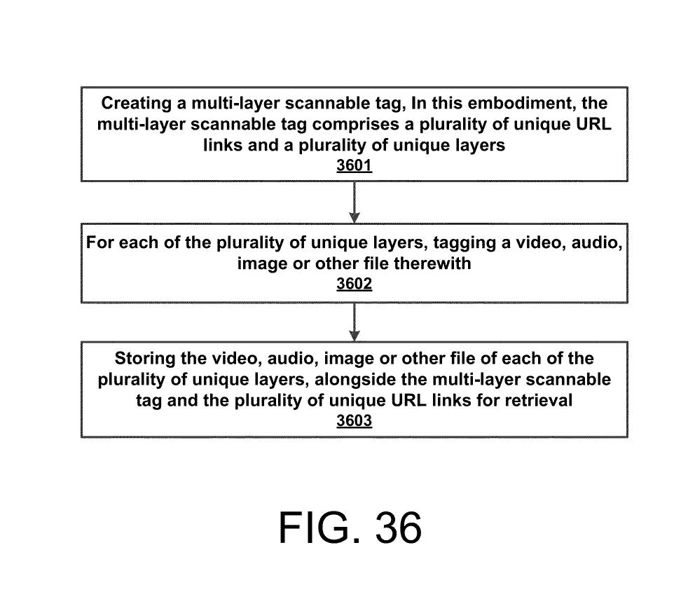

FIG. 36 is a flowchart of a method for creating a multi-layer scannable tag with a plurality of files. The method includes creating 3601 a multi-layer scannable tag, In this embodiment, the multi-layer scannable tag comprises a plurality of unique URL links and a plurality of unique layers. It will be understood that each of the plurality of unique layers embeds one of the plurality of unique URL links.

Next, the method includes for each of the plurality of unique layers, tagging 3602 a video, image, audio or other file video, image, audio or other file therewith, as well as storing 3603 the video, image, audio or other file video, image, audio or other file of each of the plurality of unique layers, alongside the multi-layer scannable tag and the plurality of unique URL links for retrieval.

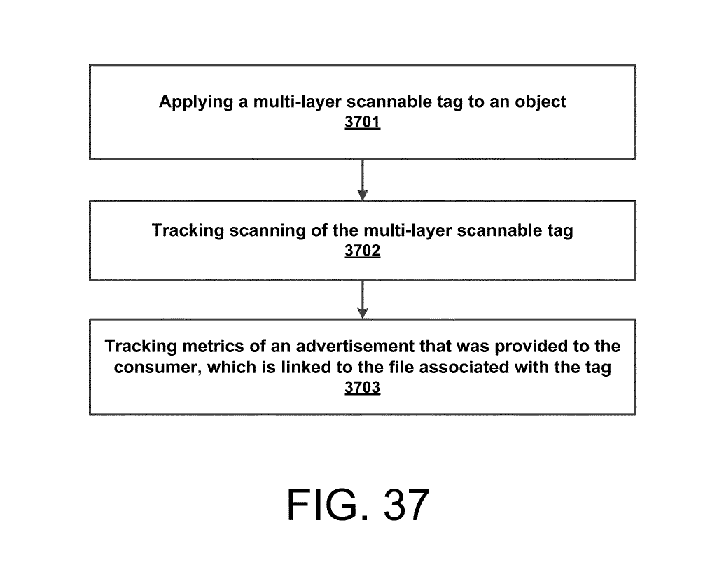

FIG. 37 is a flowchart of a method for creating a multi-layer scannable tag and associating the same with an advertisement or promotion. The method includes associating 3701 a multi-layer scannable tag and an associated file with an advertisement or promotion such that when the tag is scanned, the advertisement or promotion is provided to the viewer. This advertisement or promotion could be presented to the viewer in addition to, or in lieu of the file that is linked to the tag. For example, if a video file is linked to the tag, the method may include further linking an advertisement or promotion to the video. When the viewer plays the video file the advertisement or promotion is also presented to the viewer. In one example the advertisement may include a banner advertisement that is applied on or near the display of the video file.

The method further includes applying 3701 a multi-layer scannable tag to an object, such as a drink container or any consumer good. As mentioned above, this may include, for example, printing a QR code on the consumer good or otherwise affixing a tag to the good. The consumer good is placed into commerce and eventually is purchased by a consumer. When a consumer scans the tag the method includes tracking 3702 scanning of the multi-layer scannable tag. The tracking may include capturing the location where the tag was scanned, if the file associated with the scanned tag was downloaded, how long the consumer viewed the file, if the consumer shared the video with another party by email, messaging, or posting to social media, and so forth.

The method may also include tracking 3703 metrics of the advertisement that was provided to the consumer. In addition to the tracking that occurs for the file associated with the tag, the system may track metrics for the advertisement that is associated with the file. For example, metrics such as impressions, duration, sharing, click through, and so forth may be tracked. It will be understood that while the file may be stored in a cloud repository the advertisements or promotions associated with the file can be stored in the cloud or can be stored remotely from the file and retrieved only when the file has been requested by the consumer.

As mentioned above, the file associated with the tag may itself be an advertisement. For example, the file may include a video advertisement for the company that produces, sells, or distributes the consumer good.

FIG. 38 illustrates two display devices, which include desktop display screen 3801 and mobile display device 3802. Each is configured to display a dashboard user interface. The dashboard displayed on desktop display screen 3801 includes a file library 3803 that comprises a list of files, which in this example includes a plurality of video files. These video files belong to an owner. The first video file in the list is displayed in a frame 3805 along with metrics, which are tracked and/or calculated for the video file. In some instances the metrics are displayed to the user in a graphical format, such as graphs 3804. It will be understood that the owner can add, delete, and/or modify video files using this dashboard by clicking on one or more of the files in the list.

A mobile display device 3802 is used to display a dashboard that is similar in content to that displayed on the desktop display screen 3801, although the format is tailored to display on a smaller screen format.

According to some embodiments, the scannable code tag technology of the present technology can be leveraged to deliver gifts or rewards to a user. More specifically, but not by way of limitation, a gift or reward can be provided to the user in addition to the file or files stored for the scannable code tag.

For brevity and clarity, the word “reward” will be used throughout the following descriptions. It will be understood that the term “reward” should be construed broadly and in accordance with the embodiments described herein. A reward may include a gift such as a virtual reward or a physical reward that is provided to a user. For example, a reward may include a digital good such as a coupon, an electronic ticket, an IOU, an amount of currency, a monetary object such as a check, money order, or other electronic payment format. A reward may include a store or merchant credit or other rewards or digital goods that would be known to one or ordinary skill in the art with the present disclosure before them.

In some embodiments, a scannable code tag is a reusable printed indicia that can be printed onto an object. It is reusable because the printed indicia is placed onto an object, such as a card, letter, bag, package, or the like, and the printed indicia is not changed or reprinted. In order to activate the scannable code tag, files, such as video and audio files can be associated with the printed indicia. For example, a scannable code tag may include a barcode printed onto a box. Files can be selectively associated with the scannable code tag by storing files on a network at a location that is linked to the scannable code tag. A user can change the file associated with the scannable code tag at any time without requiring alteration of the printed indicia on the object. As with the files that can be selectively associated with the scannable code tag, rewards can also be selectively associated with the scannable code tag. These features will be described in greater detail infra.

In one example, a sender delivers something to a recipient using a box that includes a scannable code tag. The recipient can scan the scannable code tag and retrieve the file that was stored by the sender. The recipient can the reuse the box with the scannable code tag by associating the scannable code tag with a new file. The recipient can then deliver the box to a subsequent recipient. The scannable code tag can be selective associated with different files as needed or desired.

In some embodiments, a scannable code tag may include a multi-layer scannable. In these embodiments, a “layer” of a multi-layer scannable tag should be construed to include a uniquely addressable location of a scannable tag. For example, a QR code can be split into sections, and each section of the QR code can embed different types of information. The sections of the QR code would represent the layers of the multi-layer scannable tag.

For example, a first quadrant of a QR code can embed a logical link to a file, while a second quadrant of the QR code can embed a logical link to a reward that is associated with the file.

In accordance with the present disclosure, the following descriptions will reference an application “The App” as with the embodiments described supra. Conceptually, the present technology is implemented by way of a particular purpose computing device, such as a server or a mobile communications device. The App can be stored in memory and executed by a processor to perform the various functionalities described herein. These functionalities present tangible improvements to scannable barcodes and tags and related processes involving scannable barcodes.

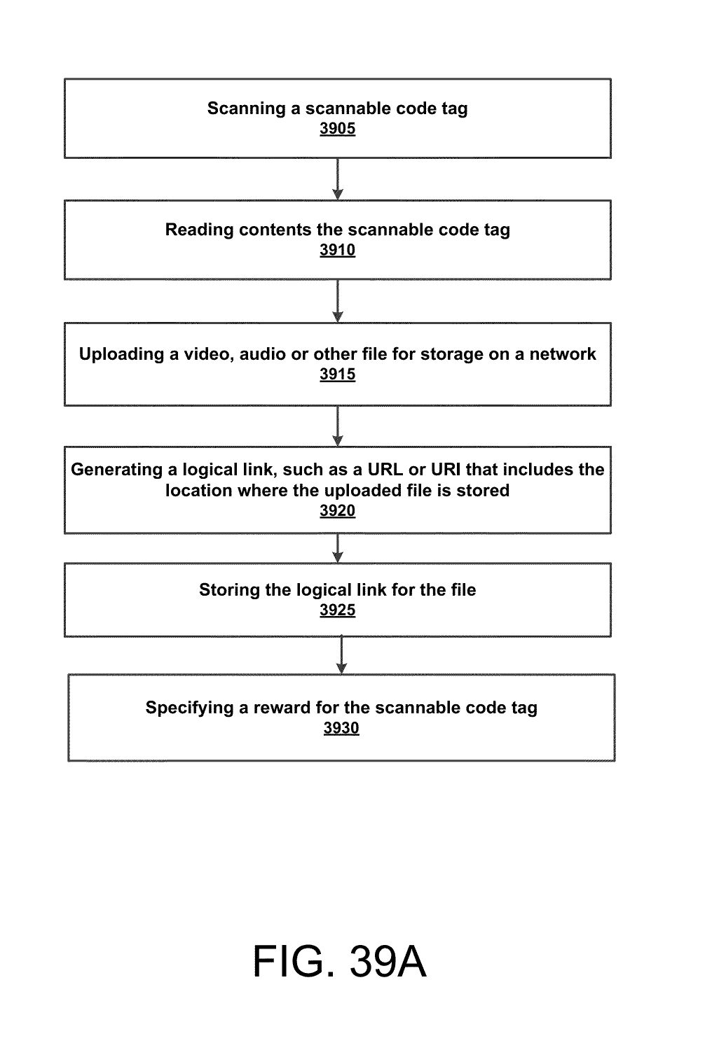

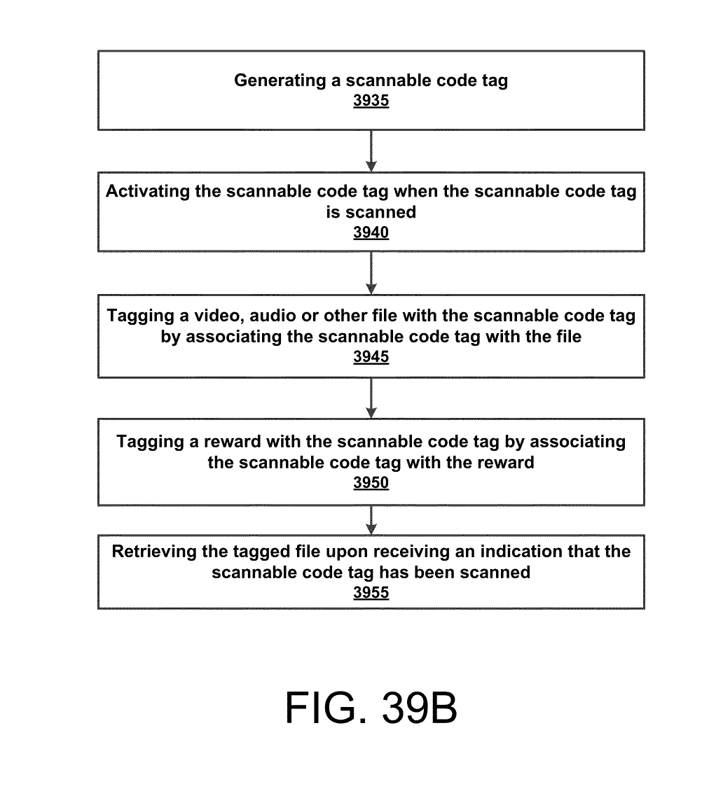

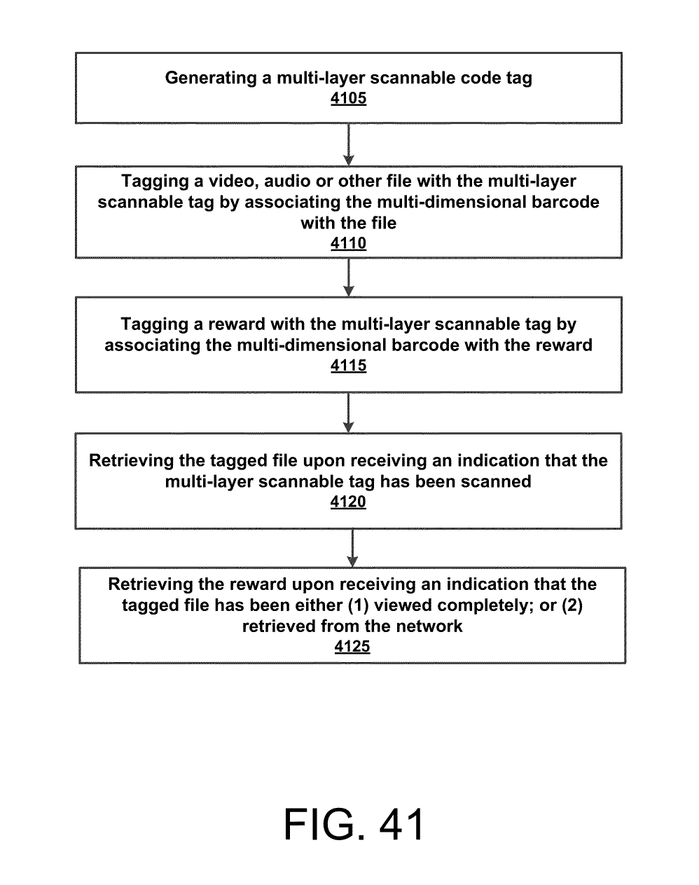

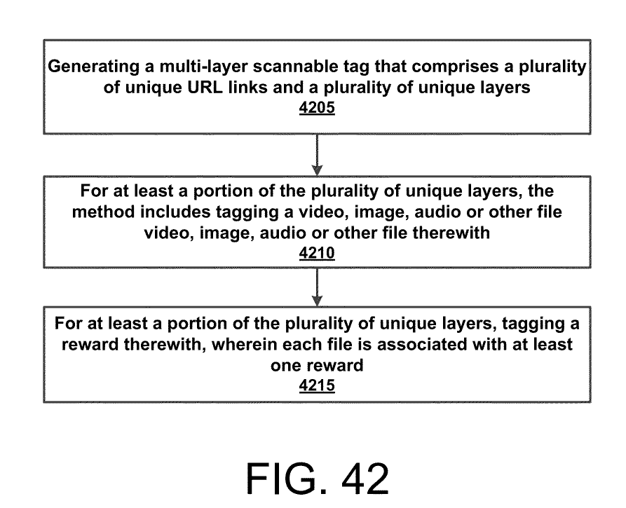

FIG. 39A is a flowchart of an example method for providing a scannable code tag that is associated with both a tagged file and a tagged reward. While the following description involves the use of a single tagged file and reward, it will be understood that the scannable tag can be multi-layered or multi-dimensional, allowing for the tag to embed a plurality of files and rewards. In such embodiments, each of the many files can be associated with one or more rewards, as will be described in greater detail with reference to FIGS. 41 and 42,

The method begins with the user scanning 3905 a scannable code tag. In one example, the scannable code tag is placed onto a birthday card. The scannable code tag may include a barcode, QR code, or even a string of alphanumeric or other characters. The scannable code tag is printed onto a portion of the birthday card in this example.

When the user purchases the birthday card at a store, the user scans the scannable code tag on the birthday card with their mobile device. The mobile device executes a scannable code tag application (The App). When the user scans the scannable code tag, the method includes The App reading 3910 contents of the scannable code tag. The App reads contents of the scannable code tag and determines that a file needs to be either (1) uploaded; or (2) replaced with a second file if one file is already associated with the scannable code tag.

If a new file is needed, the method includes The App uploading 3915 a video, audio or other file for storage on a network. For example, the user may select a file on their mobile device, such as a video or audio recording of the user saying “Happy Birthday”.

The uploaded file may be stored in cloud storage on the network. When the uploaded file is stored, the cloud may inform The App as to the location on the cloud where the uploaded file was stored. For example, the cloud may inform The App that the uploaded file was stored on a domain at an IP address such as 123.123.123.1. The location may also include, for example, a subdomain or virtual subdirectory or folder. Any method for recording and storing a file in cloud storage can be used, so long as The App is provided with a location that can be used to obtain the file at a later time.

The method further includes The App generating 3920 a logical link, such as a URL or URI that includes the location where the uploaded file is stored. For example, the file may be stored at http://example.domain.com.

The method includes The App embedding storing 3925 the logical link, for example, in a database. For example, a representation of the scannable code tag can be stored in association with the logical link. The URL provides a pointer to a location on a network where a tagged file is stored. By way of example, the scannable code tag can include a barcode that is associated with a video file that is stored on the network. The database may include the barcode and the logical link. After the scannable code tag is activated, when a user scans the barcode The App can locate the barcode in the database and obtain the URL or other logical link.

The App may also allow the user select one or more rewards that can be tagged for association with the scannable code tag. For example, The App may provide the user with a selectable list of rewards that are available from a plurality of different merchants or reward providers. In one example, The App may choose a selectable list of rewards based upon content of the uploaded file. For example, if the uploaded file is a video about a movie, the rewards may include free movie tickets or coupons for movie theater refreshments.

Alternatively, The App may choose a selectable list of rewards based upon the object that the scannable code tag is associated with. For example, if the object is a birthday card for a child, the reward may include a coupon for a children's related merchant.

In another example, the reward may include an electronic gift card that can be redeemed by a recipient of the birthday card. As with the uploaded file, a logical link for the reward may be created and stored in the database. Thus, the method may include The App specifying 3930 a reward for the scannable code tag.

For example, a merchant system may control the electronic gift card. A logical link, such as a URL or alphanumeric code can be associated with the electronic gift card. When the URL or alphanumeric code is provided to the merchant system, the merchant system will release or activate the electronic gift card.

As mentioned above, these logical links can be embedded into one or more quadrants of a QR code. If the multi-layer scannable tag is a stacked barcode, the stack layers of the barcode may be embedded with different types of logical links or information.

The creation of a scannable code tag with a file and reward will result in the activation of the scannable code tag. That is, the scannable code tag is ready for subsequent scanning and retrieval of the associated file and reward.

FIG. 39B is a flowchart of another method for generating and activating a scannable code tag. Generally, the method includes generating 3935 a scannable code tag. For example, the scannable code tag could include a string of characters, a barcode, or the like. The scannable code tag can be printed onto an object such as a letter or card.

The method further includes activating 3940 the scannable code tag when the scannable code tag is scanned. In some embodiments activating the scannable code tag includes tagging 3945 a video, audio or other file with the scannable code tag by associating the scannable code tag with the file. For example, a user may upload a file such as a video file to a network. The scannable code tag is tagged with the video file by creating a database record that includes the scannable code tag and a logical link to the video file, such as a location of the video file on the network.

Next, the method includes tagging 3950 a reward with the scannable code tag by associating the scannable code tag with the reward. As with the video file, a logical link for the reward can be stored in the database record with the scannable code tag and logical link for the video file.

When the activated, scannable code tag is scanned by a device that is using The App, the method includes retrieving 3955 the tagged file upon receiving an indication that the scannable code tag has been scanned.

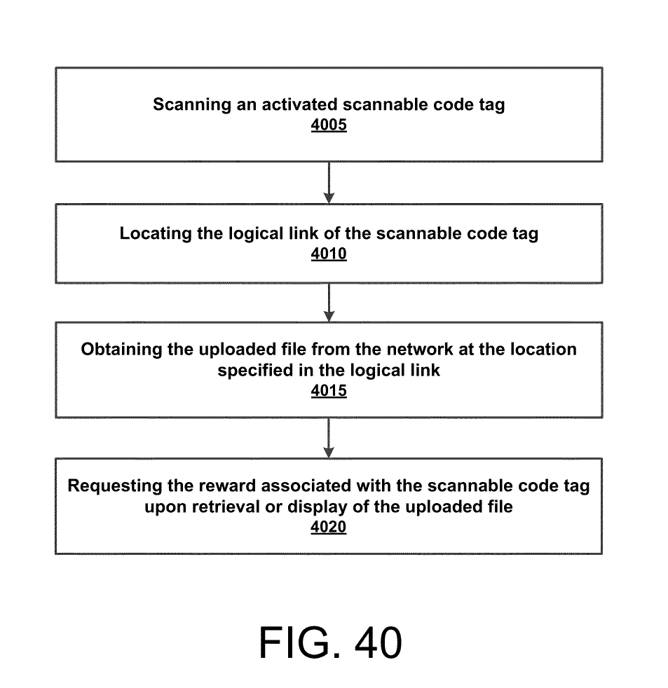

FIG. 40 is a flowchart of a method for using a scannable code tag to obtain a reward. After the uploaded file and reward have been specified and the scannable code tag created, another user can scan the active scannable code tag. Continuing with the example above, a recipient of the birthday card can scan the scannable code tag printed onto the card. Scanning the scannable code tag allows for the retrieval of the file and the reward.

Thus, in some embodiments the method includes The App scanning 4005 an activated scannable code tag. In some embodiments, the activated scannable code tag is embedded with a logical link for the uploaded file and/or one or more rewards.

The method includes The App locating the 4010 the logical link(s) of the scannable code tag. It will be understood that locating the scannable code tag may include reading an embedded link in the scannable code tag. In another embodiment, locating the logical link may include querying the scanned code tag against the database, finding a matching record for the scanned code tag and obtaining the logical link associated with the scanned code tag.

The method includes The App obtaining 4015 the uploaded file from the network at the location specified in the logical link.

After the file has been retrieved from the network and displayed to the user, the method may include The App requesting 4020 the reward associated with the scannable code tag upon retrieval or display of the uploaded file. The reward can be obtained using a second logical link that was embedded into the scannable code tag or by locating the second logical link in the database record created for the scannable code tag.

As mentioned above, the uploaded file is associated with a first logical link that indicates where the uploaded file is stored on the network. The reward can be associated with a second logical link that indicates the location of the reward. This location could be, for example, a merchant system or server that is configured to manage and provide rewards in response to requests for rewards.

In some embodiments, the reward can be retrieved and provided upon retrieval of the uploaded file. In another example, the reward is retrieved and provided only when use of uploaded file is complete. For example, if the uploaded file is a video, the reward is provided at the end of the runtime of the video. If the uploaded file is an audio file, the reward is provided at the end of the runtime of the audio file. If the uploaded file is an image, the reward is provided when the image is displayed to the user.

In some instances, the reward, or an indication/representation of the reward is displayed to the user. In another example, a link to the reward is displayed to the user. The user can click the link to retrieve the reward. In another embodiment, a message that the user has received a reward can be displayed and an email that includes a link to the reward is sent to the user. The user can retrieve the reward by clicking on the link.

If the reward is a coupon or code, the reward can be printed or displayed for use on the user's mobile device, either using The App or storing the reward locally on the device as a file and retrieving the reward file when needed.

In the example provided above, the scannable code tag includes both an uploaded file and a reward that can be used with, for example, a greeting card. This combination streamlines the gift-giving process. The card purchaser can leave a personal video or audio message for the recipient by recording the message and uploading the same for storage. The user can then select a reward for the recipient of the card. For example, the user can select a coupon to a restaurant. In the following embodiments, the scannable code tag is embodied as a multi-layer scannable tag. Generally, a multi-layer scannable tag is a scannable code tag that has multiple layers or dimensions. Each of the layers can be unique in the type of information that they embed. In some instances, logical links can be embedded into the layers.

FIG. 41 is a flowchart of a method for providing a multi-layer scannable tag. The method generally includes generating 4105 a multi-layer scannable tag. As mentioned above generating the multi-layer scannable tag comprises generating a multi-dimensional barcode or QR code or other two or three dimensional code

Next the method includes tagging 4110 a video, audio or other file with the multi-layer scannable tag by associating the multi-dimensional barcode with the file. This step may include generating a logical link or pointer that identifies a location of the file on a network. Also, the method includes tagging 4115 a reward with the multi-layer scannable tag by associating the multi-dimensional barcode with the reward. This also includes creating a logical link for the reward.

Tagging may include the process of embedding the logical links for the file and the reward in the multi-layer scannable tag. As mentioned above, the logical link for the file may be embedded onto a first layer, while the reward is embedded onto a second layer.

In some embodiments, the method may include retrieving 4120 the tagged file upon receiving an indication that the multi-layer scannable tag has been scanned. Also, the method includes retrieving 4125 the reward upon receiving an indication that the tagged file has been either (1) viewed completely; or (2) retrieved from the network.

FIG. 42 is a flowchart of another method for providing a multi-dimensional barcode. The method includes generating 4205 a multi-layer scannable tag that comprises a plurality of unique URL links and a plurality of unique layers. Each of the plurality of unique layers embedding one of the plurality of unique URL links. For example, the multi-layer scannable tag may have unique URL links for several uploaded files embedded therein. These unique URL links can be stored on the unique layers. For example, a multi-layer scannable tag may have four unique layers. Two of the layers are embedded with URL links to two uploaded files.

Next, for at least a portion of the plurality of unique layers, the method includes tagging 4210 a video, image, audio or other file video, image, audio or other file therewith. Also, the method includes, for at least a portion of the plurality of unique layers, tagging 4215 a reward therewith, wherein each file is associated with at least one reward. Continuing with the example, layers three and four of the multi-layer scannable tag are embedded with logical links to two rewards. The file of layer one is associated with the reward of layer three and the file of layer two is associated with the reward of layer four.

In accordance with the present disclosure, The App may be included in a non-transitory computer readable medium such as memory, a hard drive, cache memory, cloud storage, CPU memory, or other storage mediums described herein.

The App, can be used to scan the multi-layer scannable tag and read the various layers of the multi-layer scannable tag. The ability of The App to read the various layers of the multi-layer scannable tag may depend on a user profile of the user. For example, when a user installs The App on their mobile device, prior to scanning any multi-layer scannable tags, the user is required to setup a profile or other identifier. The creator of the multi-layer scannable tag may specify which recipients can read which layers of the multi-layer scannable tag. For example, a child may send a card to their parents. The child can embed logical links for two different videos for each parent. Also, logical links for rewards can be embedded. The child can select which parent receives which file/reward combination and The App can restrict the layers such that only the appropriate party can read them. When the child uses The App to create the multi-layer scannable tag, the child can tag the files with an identifier for a parent. The identifier can identify the profile or user ID of the parent. When each parent scans the multi-layer scannable tag, The App executing on their respective mobile devices compares the user ID or profile embedded into the file layers of the multi-layer scannable tag and allows the parent to access the file only if they are permitted.

As with other embodiments described herein, an object with a multi-layer scannable tag can be reused without needed to change the multi-layer scannable tag that is placed on the object. For example, if the multi-layer scannable tag is a QR code printed on an gift bag, the QR code need not be changed to alter the file or reward associated with the QR code. By way of example, a user can reuse a gift bag that includes a QR code by uploading a new video or audio file and associating the file with a new reward. The only changes needed are to the logical links (e.g., URLs) for the files and reward. Thus, after receiving the gift bag, the recipient can also reuse the gift bag, “reloading” the multi-layer scannable tag with new files and/or rewards.

Specific reference to components, process steps, and other elements are not intended to be limiting. Further, it is understood that like parts bear the same reference numerals, when referring to alternate Figures. It will be further noted that the Figures are schematic and provided for guidance to the skilled reader and are not necessarily drawn to scale. Rather, the various drawing scales, aspect ratios, and numbers of components shown in the Figures may be purposely distorted to make certain features or relationships easier to understand.

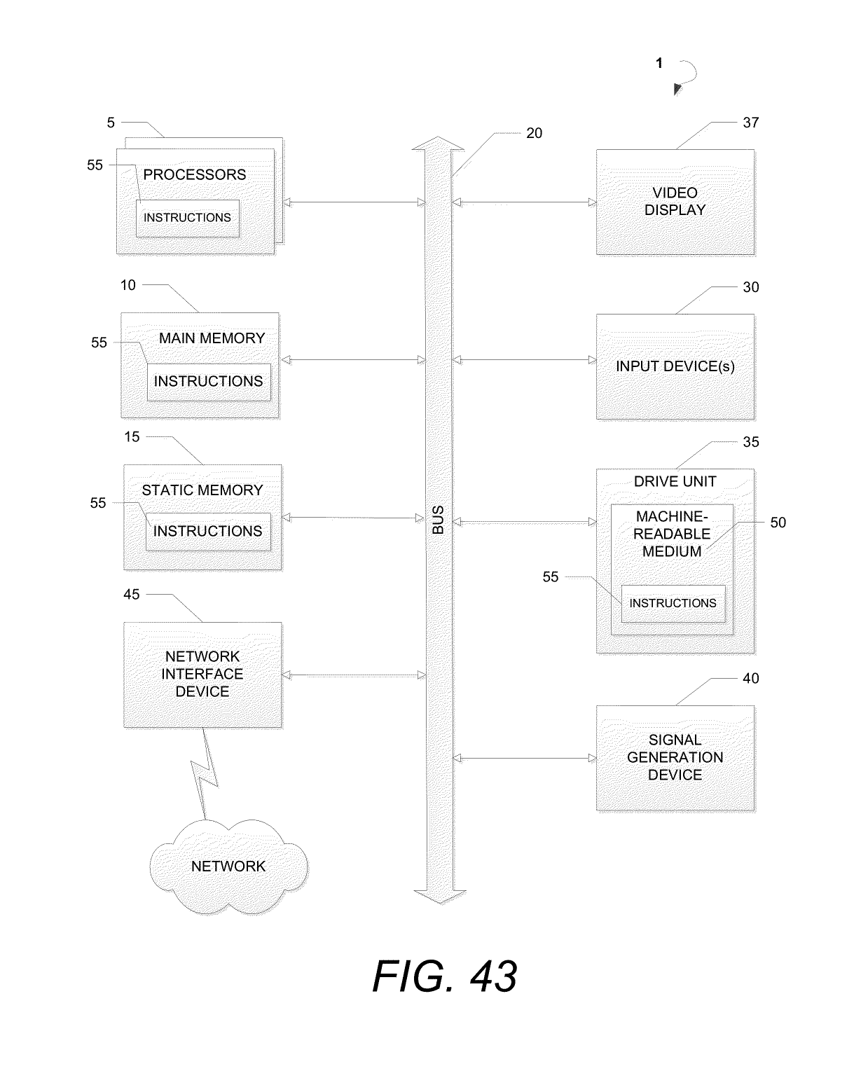

FIG. 43 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 37 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 35 (also referred to as disk drive unit), a signal generation device 40 (e.g., a speaker), and a network interface device 45. The computer system 1 may further include a data encryption module (not shown) to encrypt data.

The drive unit 35 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

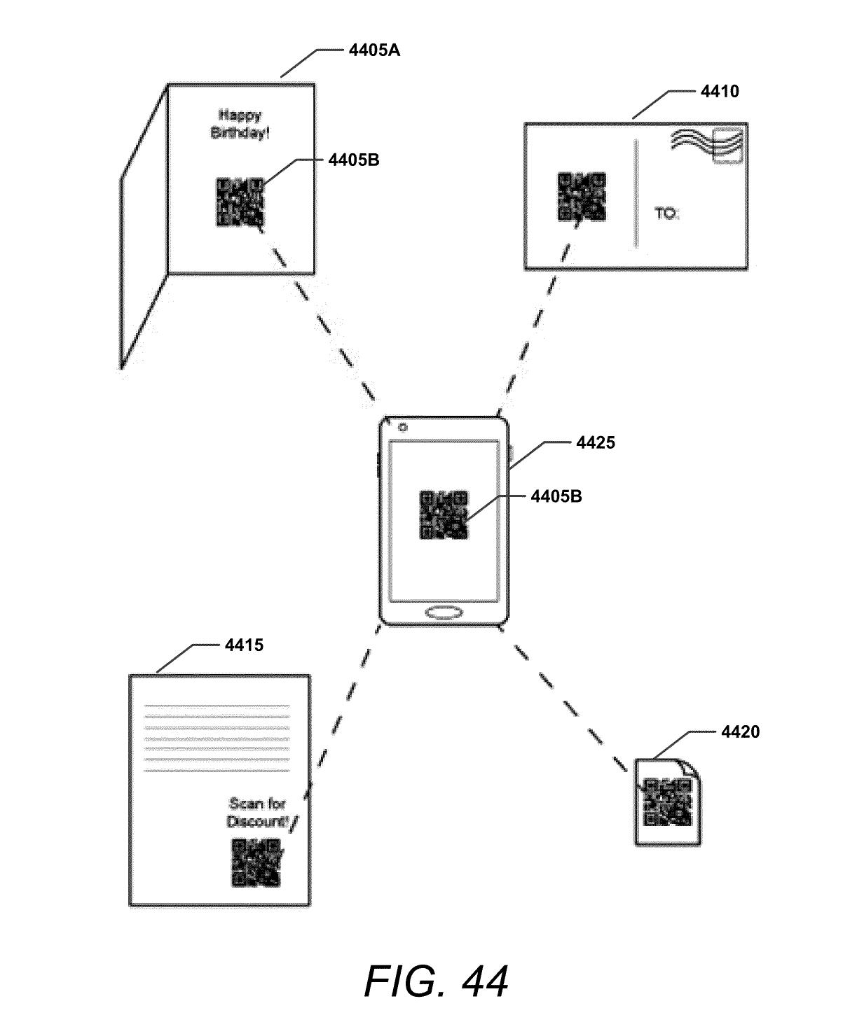

FIG. 44 illustrates a mobile device scanning a scannable code tag associated with one of a plurality of objects. In one example, a greeting card 4405A is printed with a scannable code tag 4405B. A mobile device 4425 scans the scannable code tag 4405B, which is then displayed on the mobile device 4425.

In other examples, a scannable code tag can be printed on other types of objects such as a postcard or envelope 4410, a letter or invoice 4415, or alternatively a sticker or tab 4420. Again, these are merely examples of objects that can be provided or printed with a scannable code tag of the present technology.

In an example use case, a recipient receives the greeting card 4405A from a sender. As mentioned above, prior to providing the recipient with the greeting card 4405A, the sender scans the scannable code tag 4405B of the greeting card 4405A and completes the process of uploading a message or video for the recipient. The message is stored in cloud storage at a location that can be defined by a logical link. The storage location on the cloud and the logical link may already exist and the sender needs only to upload the message for storage. In other instances, the storage location needs to be created and a logical link defined, such as when the scannable code tag 4405B is being used for a first time.

Also, the sender can choose a gift (e.g., reward) for the recipient, such as a gift card, a coupon or the like. The gift can be set up for delivery to the recipient by way of email. Thus, the sender inputs the email address of the recipient for delivery of the gift.

Once the greeting card 4405A is received by the recipient, the recipient scans the scannable code tag 4405B. The message is delivered to the recipient and an email is sent to the recipient's email address.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated. Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the described embodiments of the invention are illustrative only and that modifications thereof may occur to those skilled in the art. Accordingly, this invention is not to be regarded as limited to the embodiments disclosed, but is to be limited only as defined by the appended claims herein. It will further be understood that any features described in relation to any particular embodiment may be featured in combinations with other embodiments, for avoidance of doubt.

### REFERENCES

### Incorporated Herein by Reference

Please find references below.

What is claimed is:

1. A method for providing a reusable scannable code tag, the method comprising:
generating a scannable code tag; and
activating the scannable code tag when the scannable code tag is scanned,
wherein activating the scannable code tag comprises:
tagging a video, audio or other file with the scannable code tag by associating the scannable code tag with the file; and
tagging a reward with the scannable code tag by associating the scannable code tag with the reward.

2. The method according to claim 1, wherein tagging comprises:
generating a logical link, the logical link comprising a location of the file on a network; and
storing the file on the network at the location.

3. The method according to claim 2, further comprising:
tagging a replacement video, audio or other file by associating the replacement file with the logical link by storing the replacement video on the network at the location.

4. The method according to claim 1, further comprising receiving a message that the file has been retrieved; and retrieving the reward upon receiving the message.

5. The method according to claim 1, further comprising receiving a message that the file has been displayed; and retrieving the reward upon receiving the message.

6. The method according to claim 1, wherein the gift comprises any of a coupon, a gift certificate, a voucher, credit, a digital good, or any combinations thereof.

7. The method according to claim 1, wherein the scannable code tag comprises a multi-layer scannable tag.

8. The method according to claim 7, wherein the multi-layer scannable tag comprises logical links that are embedded into layers of the multi-layer scannable tag, wherein one layer includes a logical link for the tagged file and another layer includes a logical link for the reward.

9. The method according to claim 1, further comprising retrieving the tagged file upon receiving an indication that the scannable code tag has been scanned.

10. A non-transitory computer readable storage media having a program embodied thereon, the program being executable by a processor to perform a method for providing a reusable scannable code tag, the method comprising:
generating a scannable code tag; and
activating the scannable code tag when the scannable code tag is scanned,
wherein activating the scannable code tag comprises:
tagging a video, audio or other file with the scannable code tag by associating the scannable code tag with the file; and
tagging a reward with the scannable code tag by associating the scannable code tag with the reward.

11. The non-transitory computer readable storage media according to claim 10, wherein tagging the file comprises:
generating a logical link, the logical link comprising a location of the file on a network; and
storing the file on the network at the location.

12. The non-transitory computer readable storage media according to claim 11, further comprising:
tagging a replacement video, audio or other file by associating the replacement file with the logical link by storing the replacement video on the network at the location.

13. The non-transitory computer readable storage media according to claim 10, further comprising receiving a message that the file has been retrieved; and retrieving the reward upon receiving the message.

14. The non-transitory computer readable storage media according to claim 10, further comprising receiving a message that the file has been replayed; and retrieving the gift upon receiving the message.

15. The non-transitory computer readable storage media according to claim 10, wherein the reward comprises any of a coupon, a gift certificate, a voucher, credit, or any combinations thereof.

16. The non-transitory computer readable storage media according to claim 10, transmitting a link to the reward in an email message.

17. The non-transitory computer readable storage media according to claim 10, further comprising retrieving the tagged file upon receiving an indication that the scannable code tag has been scanned.

18. A method for creating a multi-layer scannable tag, comprising:
generating a multi-layer scannable tag, the multi-layer scannable tag comprising a plurality of unique URL links and a plurality of unique layers, each of the plurality of unique layers embedding one of the plurality of unique URL links;
for at least a portion of the plurality of unique layers, tagging a video, image, audio or other file video, image, audio or other file therewith; and
for at least a portion of the plurality of unique layers, tagging a reward therewith, wherein each file is associated with at least one reward.

19. The method according to claim 18, further comprising retrieving the tagged file upon receiving an indication that a unique layer of the plurality of unique layers has been scanned.

20. The method according to claim 19, further comprising selecting one of the plurality of unique layers to read when the multi-layer scannable tag is scanned.

21. The method according to claim 20, wherein selecting one of the plurality of unique layers to read is based upon device characteristics of the computing device that scanned the multi-layer scannable tag.

22. A method for creating and applying a scannable code tag, the method comprising:
generating a scannable code tag;
applying the tag to a consumer good; and
activating the scannable code tag when the scannable code tag is scanned,
wherein activating the scannable code tag comprises:
tagging a video, audio or other file with the scannable code tag by associating the scannable code tag with the file; and
tagging a reward with the scannable code tag by associating the scannable code tag with the reward.

23. The method according to claim 22, wherein applying the tag to a consumer good comprises printing the scannable code tag on an object.

24. The method according to claim 23, wherein the object is a greeting card.
